(19) United States
(12) Patent Application Publication
(10) Pub. No.: US 2026/0222764 A1
(43) Pub. Date: Jul. 30, 2026

(54) SYSTEM AND METHOD FOR INTELLIGENT MEDIA CONFIGURATION AND PLAYOUT BASED ON POSITIONING

(71) Applicant: QUALCOMM Incorporated, San Diego, CA (US)

(72) Inventors: Pruthvi Raj SINGH, Hyderabad (IN); Vishnu Vardhan KASILIYA SUDARSAN, Bangalore (IN); Srivathsa SRIDHARA, Bengaluru (IN)

(21) Appl. No.: 19/036,592

(22) Filed: Jan. 24, 2025

(51) Int. Cl. H04W 4/02; H04L 9/40; H04S 7/00

(52) U.S. Cl. CPC H04W 4/023; H04L 63/10; H04S 7/302

(57) ABSTRACT

A device includes a memory configured to store configurations of multiple media services that are associated with one or more user equipments (UEs). The device also includes one or more processors coupled to the memory and configured to perform one or more wireless positioning operations to determine a relative position of a UE of the one or more UEs with respect to an interior of a vehicle and identify a user class associated with the UE based on the relative position of the UE. The user class is associated with permissions for one or more media services of the multiple media services. The one or more processors are configured to modify, based on the permissions, a set of configurations that are associated with the one or more media services and the UE and selectively enable playout of audio, via one or more speakers, based on the modified set of configurations.

### I. FIELD

The present disclosure is generally related to intelligent management of media configuration and playout based on relative positions of user equipments.

### II. DESCRIPTION OF RELATED ART

Advances in technology have resulted in smaller and more powerful computing devices. For example, there currently exist a variety of portable personal computing devices, including wireless telephones such as mobile and smart phones, tablets and laptop computers that are small, lightweight, and easily carried by users. These devices can communicate voice and data packets over wireless networks. Further, many such devices incorporate additional functionality such as a digital still camera, a digital video camera, a digital recorder, and an audio file player. Also, such devices can process executable instructions, including software applications, such as a web browser application, that can be used to access the Internet. As such, these devices can include significant computing capabilities.

Vehicle infotainment systems are capable of supporting wireless connections with multiple user equipment (UEs), such as portable electronic devices (e.g., mobile phones), for the purpose of providing access to various media services through one or more components of the vehicle. For example, an infotainment system within the vehicle may enable a UE to control a streaming audio service or a hands-free call supported by the infotainment system. However, the infotainment system may have difficulty prioritizing and dealing with situations where multiple UEs are configured to access the same services via the infotainment system. For example, if a UE is connected to the infotainment system such as for streaming music for playout by speakers of the vehicle, the music may be interrupted if the UE receives a phone call. As another example, if the UE belongs to a passenger, the infotainment system may block a request to initiate a hands-free call from a driver's UE due to the passenger's UE playing out the streaming audio at the speakers.

### III. SUMMARY

According to one implementation of the present disclosure, a device includes a memory configured to store configurations of a plurality of media services, the configurations associated with one or more user equipments (UEs). The device also includes one or more processors coupled to the memory. The one or more processors are configured to perform one or more wireless positioning operations to determine a relative position of a UE of the one or more UEs with respect to an interior of a vehicle. The one or more processors are also configured to identify a user class associated with the UE based on the relative position of the UE. The user class is associated with permissions for one or more media services of the plurality of media services, The one or more processors are also configured to modify, based on the permissions, a set of configurations that are associated with the one or more media services and the UE. The one or more processors are also configured to selectively enable playout of audio, via one or more speakers, based on the modified set of configurations.

According to another implementation of the present disclosure, a method includes performing, by one or more processors, one or more wireless positioning operations to determine a relative position of a UE of one or more UEs with respect to an interior of a vehicle. The one or more UEs are associated with configurations of a plurality of media services. The method also includes identifying, by the one or more processors, a user class associated with the UE based on the relative position of the UE. The user class is associated with permissions for one or more media services of the plurality of media services. The method also includes modifying, by the one or more processors and based on the permissions, a set of configurations that are associated with the one or more media services and the UE. The method also includes selectively enabling playout of audio, by the one or more processors and via one or more speakers, based on the modified set of configurations.

According to another implementation of the present disclosure, a non-transitory computer-readable medium stores instructions that are executable by one or more processors to cause the one or more processors to perform one or more wireless positioning operations to determine a relative position of a UE of one or more UEs with respect to an interior of a vehicle. The one or more UEs are associated with configurations of a plurality of media services. The instructions also cause the one or more processors to identify a user class associated with the UE based on the relative position of the UE. The user class is associated with permissions for one or more media services of the plurality of media services. The instructions also cause the one or more processors to modify, based on the permissions, a set of configurations that are associated with the one or more media services and the UE. The instructions also cause the one or more processors to selectively enable playout of audio, via one or more speakers, based on the modified set of configurations.

According to another implementation of the present disclosure, an apparatus includes means for performing one or more wireless positioning operations to determine a relative position of a UE of one or more UEs with respect to an interior of a vehicle. The one or more UEs are associated with configurations of a plurality of media services. The apparatus also includes means for identifying a user class associated with the UE based on the relative position of the UE. The user class is associated with permissions for one or more media services of the plurality of media services. The apparatus also includes means for modifying, based on the permissions, a set of configurations that are associated with the one or more media services and the UE. The apparatus also includes means for selectively enabling playout of audio, via one or more speakers, based on the modified set of configurations.

Other aspects, advantages, and features of the present disclosure will become apparent after review of the entire application, including the following sections: Brief Description of the Drawings, Detailed Description, and the Claims.

### IV. BRIEF DESCRIPTION OF THE DRAWINGS

FIG. 1 is a block diagram of an example of a system including a device operable to support media configuration and playout based on positioning, in accordance with one or more aspects of the present disclosure.

FIG. 2 is a diagram of an example in which the device of FIG. 1 is integrated in or included in a vehicle, in accordance with one or more aspects of the present disclosure.

FIGS. 3A-3C are diagrams of examples of operations associated with media configuration and playout based on positioning that are performed by the vehicle of FIG. 2, in accordance with one or more aspects of the present disclosure.

FIG. 4 is a diagram of an example process for modifying media configurations and selectively playing out media based on positioning, in accordance with one or more aspects of the present disclosure.

FIG. 5 is a diagram of an example of an integrated circuit operable to support media configuration and playout based on positioning, in accordance with some examples of the present disclosure.

FIG. 6 is a diagram of a mobile device operable to support media configuration and playout based on positioning, in accordance with some examples of the present disclosure.

FIG. 7 is a diagram of a first example of a vehicle operable to support media configuration and playout based on positioning, in accordance with some examples of the present disclosure.

FIG. 8 is a diagram of a second example of a vehicle operable to support media configuration and playout based on positioning, in accordance with some examples of the present disclosure.

FIG. 9 is a diagram of a third example of a vehicle operable to support media configuration and playout based on positioning, in accordance with some examples of the present disclosure.

FIG. 10 is a diagram of an example of a method of media configuration and playout based on positioning, in accordance with some aspects of the present disclosure.

FIG. 11 is a block diagram of an illustrative example of a device that is operable to support media configuration and playout based on positioning, in accordance with one or more aspects of the present disclosure.

### V. DETAILED DESCRIPTION

The present disclosure provides systems, apparatus, methods, and computer-readable media for intelligent management of media configuration and playout based on relative positions of user equipments (UEs), such as within a vehicle. Aspects disclosed herein enable a device, such as an infotainment system of the vehicle, to determine the relative positions of the UEs, identify user classes associated with the UEs based on the relative positions, modify configurations for media services based on the permissions associated with the user classes, and selectively enable playout of media content based on the modified configurations. To illustrate, the device may perform one or more wireless positioning operations with respect to the UEs to determine the relative positions of the UEs. For example, the wireless positioning operations may include one or more ranging operations according to an ultra-wideband (UWB) protocol, one or more direction operations according to a Bluetooth® (BT) protocol or a Bluetooth low energy (BLE) protocol, one or more channel sounding operations according to the BT protocol or the BLE protocol, other positioning operations, or a combination thereof (Bluetooth® is a registered trademark of Bluetooth SIG, Inc, a Delaware corporation). The relative positions of the UEs may correspond to being positioned within one of multiple regions defined for the vehicle. For example, an operator region (e.g., a driver region) and one or more non-operator occupant regions may be defined within the vehicle based on expected seating positions of the corresponding occupants, and the wireless positioning operations may be performed to determine a location of each UE within one of the defined regions based on a fixed location of the device (e.g., the infotainment system) and the signaling included in the wireless positioning operations.

After identifying the relative positions of the UE, the device may identify user classes associated with the UEs based on the relative positions. As non-limiting examples, a UE that is determined to be positioned within the operator region may be identified as belonging to an operator class, and a UE that is determined to be positioned in a non-operator occupant region may be identified as belonging to a non-operator occupant class. Other examples of classes include front row occupants, back row occupants, parents, children, etc. Each of the classes may be associated with respective permissions for one or more media services, such as a hands-free calling service, an audio streaming service, and the like. The permissions may indicate the priority of a particular class for controlling the media playout of the device with output that corresponds to a respective media service. For example, an operator occupant may have higher priority for a hands-free calling service than a non-operator occupant, the non-operator occupant may have higher priority for an audio streaming service than the operator occupant, and the hands-free calling service may have a higher priority than the audio streaming service.

The device may modify configurations for the media services based on the permissions associated with the user classes. For example, if the device receives request to playout media associated with the hands-free calling service from both a first UE positioned within the occupant region of the vehicle and a second UE positioned within a non-operator occupant region of the vehicle (both of which indicate the respective UE is authorized to request use of the device to support the hands-free calling service), the device may modify the configurations for the hands-free calling service to indicate that the UE positioned within the operator region has a higher priority for the hands-free calling service than the UE positioned within the non-operator occupant region. As such, when the device receives requests to playout media associated with the hands-free calling service from both UEs, the device selects the audio associated with the hands-free calling service from the UE positioned within the operator region for playout via one or more speakers within the vehicle. Similarly, the device may modify the configurations for the audio streaming service to indicate that the UE positioned within the non-operator occupant region has a higher priority for the audio streaming service than the UE positioned within the operator region. If requests for audio playout associated with the audio streaming service are received from both UEs, the device selects the audio associated with the audio streaming service from the UE positioned within the non-operator occupant position for playout via the one or more speakers, until the device receives a request for the hands-free audio service from the UE positioned in the operator region, as the hands-free calling service has higher overall priority than the audio streaming service.

Particular implementations of the subject matter described in this disclosure can be implemented to realize one or more of the following technical advantages. In some aspects, the present disclosure provides techniques for supporting intelligent selection of media playout based on relative positions of UEs within a vehicle and without requiring configuring, by users, of the UEs or of an infotainment system of the vehicle. As an illustrative example, by automatically selecting between playout of audio (or other media) associated with either a hands-free calling service and an audio streaming service requested by various UEs, the systems and methods described herein can provide a seamless media experience that also increases safety of the operator and the non-operators of a vehicle. To illustrate, without requiring manual configuration by the operator, a device may generate audio of a hands-free calling service requested by a first UE based on a determination that the first UE is located within an operator region of the vehicle (and that the hands-free calling service has a higher priority than a streaming media service or other services). Providing this automatic, intelligent selection of output media reduces operator distraction by obviating the need for the operator to select a service to be supported by the device and by associating lower priority and more distracting services, like a streaming media service, with UEs that are located in non-operator regions, so that the operator is not distracted interacting with such services while operating the vehicle.

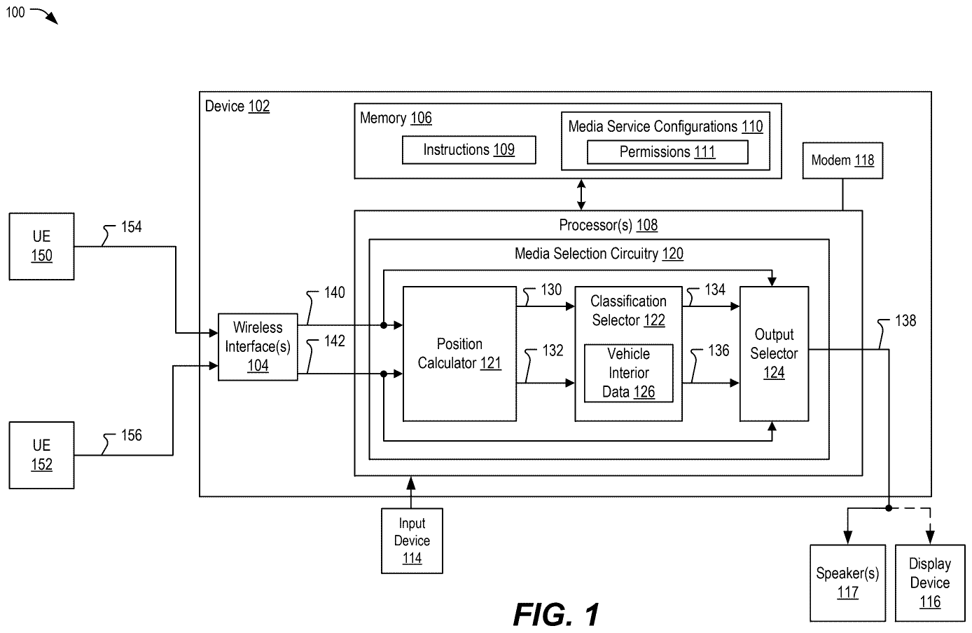

Particular aspects of the present disclosure are described below with reference to the drawings. In the description, common features are designated by common reference numbers. As used herein, various terminology is used for the purpose of describing particular implementations only and is not intended to be limiting of implementations. For example, the singular forms “a,” “an,” and “the” are intended to include the plural forms as well, unless the context clearly indicates otherwise. Further, some features described herein are singular in some implementations and plural in other implementations. To illustrate, FIG. 1 depicts a device 102 including one or more processors (“processor(s)” 108 of FIG. 1), which indicates that in some implementations the device 102 includes a single processor 108 and in other implementations the device 102 includes multiple processors 108. For ease of reference herein, such features are generally introduced as “one or more” features and are subsequently referred to in the singular or optional plural (as indicated by “(s)”) unless aspects related to multiple of the features are being described.

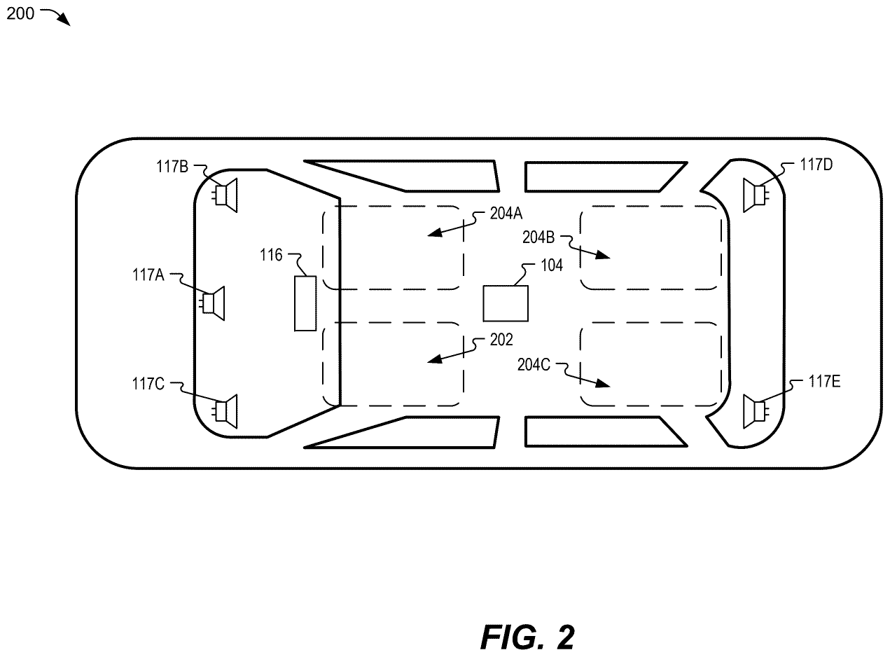

In some drawings, multiple instances of a particular type of feature are used. Although these features are physically and/or logically distinct, the same reference number is used for each, and the different instances are distinguished by addition of a letter to the reference number. When the features as a group or a type are referred to herein-e.g., when no particular one of the features is being referenced, the reference number is used without a distinguishing letter. However, when one particular feature of multiple features of the same type is referred to herein, the reference number is used with the distinguishing letter. For example, referring to FIG. 2, multiple speakers are illustrated and associated with reference numbers 117A, 117B, 117C, 117D, 117E. When referring to a particular one of these speakers, such as a speaker 117A, the distinguishing letter “A” is used. However, when referring to any arbitrary one of these speakers or to these speakers as a group, the reference number 117 is used without a distinguishing letter.

As used herein, the terms “comprise,” “comprises,” and “comprising” may be used interchangeably with “include,” “includes,” or “including.” Additionally, the term “wherein” may be used interchangeably with “where.” As used herein, “exemplary” indicates an example, an implementation, and/or an aspect, and should not be construed as limiting or as indicating a preference or a preferred implementation. As used herein, an ordinal term (e.g., “first,” “second,” “third,” etc.) used to modify an element, such as a structure, a component, an operation, etc., does not by itself indicate any priority or order of the element with respect to another element, but rather merely distinguishes the element from another element having a same name (but for use of the ordinal term). As used herein, the term “set” refers to one or more of a particular element, and the term “plurality” refers to multiple (e.g., two or more) of a particular element.

As used herein, “coupled” may include “communicatively coupled,” “electrically coupled,” or “physically coupled,” and may also (or alternatively) include any combinations thereof. Two devices (or components) may be coupled (e.g., communicatively coupled, electrically coupled, or physically coupled) directly or indirectly via one or more other devices, components, wires, buses, networks (e.g., a wired network, a wireless network, or a combination thereof), etc. Two devices (or components) that are electrically coupled may be included in the same device or in different devices and may be connected via electronics, one or more connectors, or inductive coupling, as illustrative, non-limiting examples. In some implementations, two devices (or components) that are communicatively coupled, such as in electrical communication, may send and receive signals (e.g., digital signals or analog signals) directly or indirectly, via one or more wires, buses, networks, etc. As used herein, “directly coupled” may include two devices that are coupled (e.g., communicatively coupled, electrically coupled, or physically coupled) without intervening components.

In the present disclosure, terms such as “obtaining,” “determining,” “calculating,” “estimating,” “shifting,” “adjusting,” etc. may be used to describe how one or more operations are performed. It should be noted that such terms are not to be construed as limiting and other techniques may be utilized to perform similar operations. Additionally, as referred to herein, “obtaining,” “generating,” “calculating,” “estimating,” “using,” “selecting,” “accessing,” and “determining” may be used interchangeably. For example, “obtaining,” “generating,” “calculating,” “estimating,” or “determining” a parameter (or a signal) may refer to actively generating, estimating, calculating, or determining the parameter (or the signal) or may refer to using, selecting, or accessing the parameter (or signal) that is already generated, such as by another component or device.

FIG. 1 is a block diagram of an example of a system 100 including a device 102 operable to support media configuration and playout based on positioning, in accordance with one or more aspects of the present disclosure. The system 100 includes one or more user equipments (UEs), such as a UE 150 and a UE 152, and the device 102 is communicatively coupled to the UEs 150, 152 and supports intelligent media (e.g., audio, video, or other multimedia) playout selection based on positioning. For example, the device 102 may be configured to determine a relative position of UEs with respect to an interior of a vehicle, identify user classes associated with the UEs based on the relative position, modify configurations for media services based on the permissions associated with the user classes, and selectively enable playout of media content, such as audio, based on the modified configurations, as further described herein. The UEs 150, 152 may include or correspond to one or more smart phones, one or more mobile phones, one or more tablet computer devices, one or more wearable electronic devices, or a combination thereof. In some embodiments, the system 100 is incorporated or integrated in a vehicle, the UEs 150, 152 may be located within an interior of the vehicle, and the device 102 may include or correspond to an infotainment system of the vehicle, as further described herein with reference to FIG. 2.

The device 102 includes, or is coupled to, a memory 106, one or more processors 108 (collectively referred to herein as the “processor 108”), one or more wireless interfaces 104 (collectively referred to herein as the “wireless interface 104”), an optional input device 114, an optional display device 116, one or more speakers 117 (collectively referred to herein as the “speakers 117”), and an optional modem 118. Although the input device 114, the display device 116, and the speakers 117 are illustrated as components that are distinct from, and coupled to, the device 102, in other embodiments, one or more (or all) of the input device 114, the display device 116, and the speakers 117 are included in or integrated in the device 102. Although the optional components 114, 116, and 118 are depicted in FIG. 1 as included in the device 102, in other embodiments, one or more of the input device 114, the display device 116, and the modem 118 may be omitted from the device 102, as further described herein.

The wireless interface 104 is configured to support wireless communications with the UEs 150, 152 according to one or more wireless communication protocols, such as a UWB protocol, a BT protocol, a BLE protocol, a Wi-Fi® protocol, other protocols, or a combination thereof (Wi-Fi® is a registered trademark of the Wi-Fi Alliance Corp., a California corporation). For example, the wireless interface 104 may wirelessly receive a first set of messages 154 from the UE 150 and a second set of messages 156 from the UE 152. The received messages from the UE 150 and the UE 152, as well as received media data (e.g., audio data, video data, multimedia data, etc.) may be provided to the processor 108 and referred to herein as “first received data 140” and “second received data 142,” respectively, to indicate that the received data 140 and 142 include messages that were wirelessly received at the wireless interface 104 of the device 102 (even though the received data 140 and 142 may be transferred between the wireless interface 104 and the processor 108 via one or more wired connections). The wireless interface 104 may be configured to transmit, receive, or both, one or more signals associated with the one or more wireless positioning operations to enable positions of the UEs 150, 152 to be determined, as further described herein. Additionally, or alternatively, the wireless interface 104 may be configured to receive requests from the UEs 150, 152 to stream media, streaming media content from the UEs 150, 152, media service configuration data from the UEs 150, 152, other data or communications from the UEs 150, 152, or a combination thereof, included in the sets of messages 154, 156. Additionally, or alternatively, the wireless interface 104 may be configured to communicate with another device to receive any of the above-described data or communications.

The memory 106 may include one or more memory devices, such as a single memory device or multiple different memory devices (of the same type or of different types). The memory 106 is configured to store instructions 109 and media service configurations 110. The media service configurations 110 can include or indicate permissions 111 that are associated with users or user classes for one or more media services that correspond to the media service configurations 110 and that are supported by the device 102, such as a hands-free calling service, an audio streaming service, a navigation service, virtual reality (VR) service, an augmented reality (AR) service, an extended reality (XR) service, a game service, other media services, or a combination thereof. The services may be associated with a BT protocol, a Bluetooth low energy (BLE) protocol, a low energy (LE) audio protocol, or the like. In some examples, the memory 106 also includes or stores the instructions 109 that, when executed by the processor 108, cause the processor 108 to perform one or more operations as described herein. In some examples, the memory 106 stores other information or data, such as UE identifiers, media data that represents media content for playout in addition to streaming media content, trigger condition data, prioritization data, or a combination thereof.

The processor 108 includes media selection circuitry 120 that is configured to support intelligent media (e.g., audio) playout selection based on positioning of UEs. In some examples, the media selection circuitry 120 includes a position calculator 121, a classification selector 122, and an output selector 124. Each of the media selection circuitry 120, the position calculator 121, the classification selector 122, the output selector 124, or a portion thereof, may be implemented by the processor 108 executing instructions (e.g., software), dedicated hardware (e.g., circuitry), a combination thereof.

The position calculator 121 is configured to perform wireless positioning operations to determine relative positions of UE(s) with respect to an interior of the vehicle (in which the system 100 is located). For example, the position calculator 121 may perform one or more wireless positioning operations based on the first received data 140 to generate first position data 130 that indicates a relative position of the UE 150 with respect to the interior of the vehicle. The position calculator 121 may also perform one or more wireless positioning operations based on the second received data 142 to generate second position data 132 that indicates a relative position of the UE 152 with respect to the interior of the vehicle. The wireless positioning operations may include one or more ranging operations according to the UWB protocol, one or more direction operations according to the BT protocol, one or more channel sounding operations according to the BT protocol, other positioning operations, or a combination thereof. The direction operations may include direction finding operations using angle of arrival (AoA) determined by the device 102 or using angle of departure (AoD) determined by the UEs 150, 152 (and fed back to the device 102). The determined positioning data may represent a position of the respective UE relative to the device 102 (e.g., relative to one or more antennas of the wireless interface 104 of the device 102), a distance between the respective UE and the device 102, a direction from the device 102 to the respective UE, other positioning, or a combination thereof.

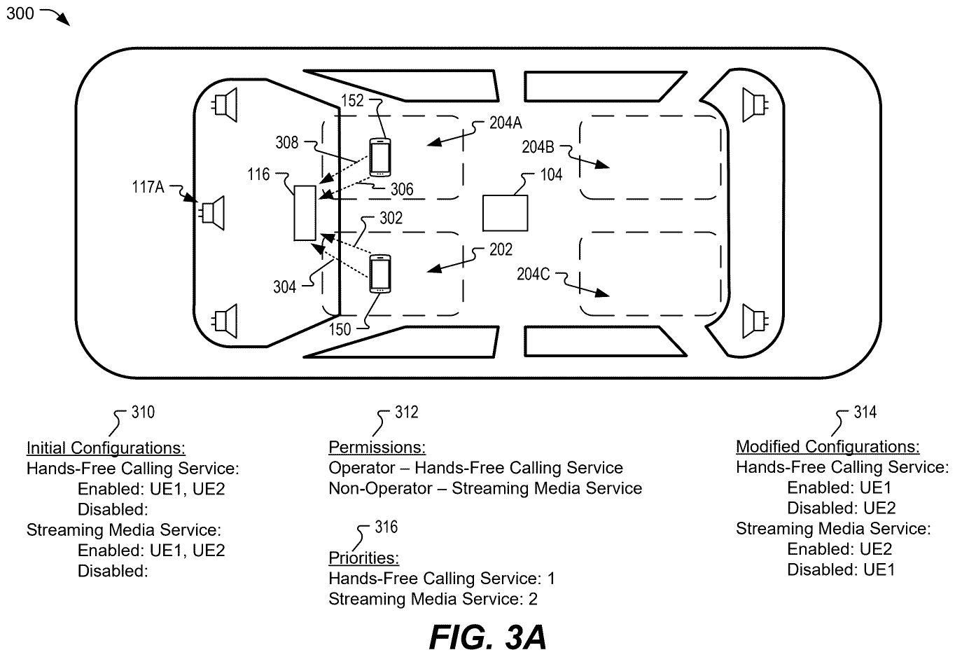

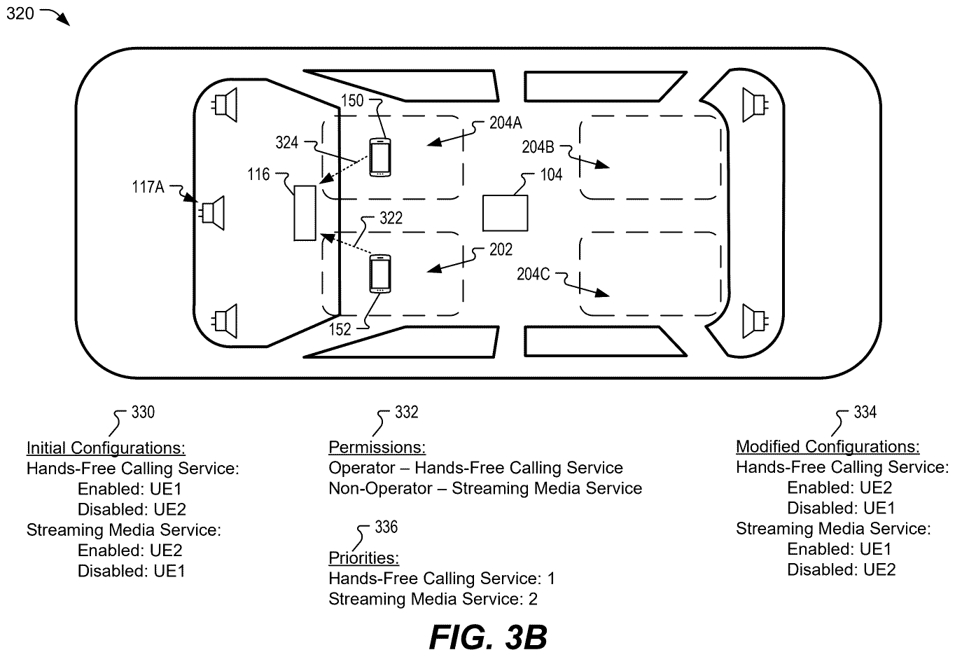

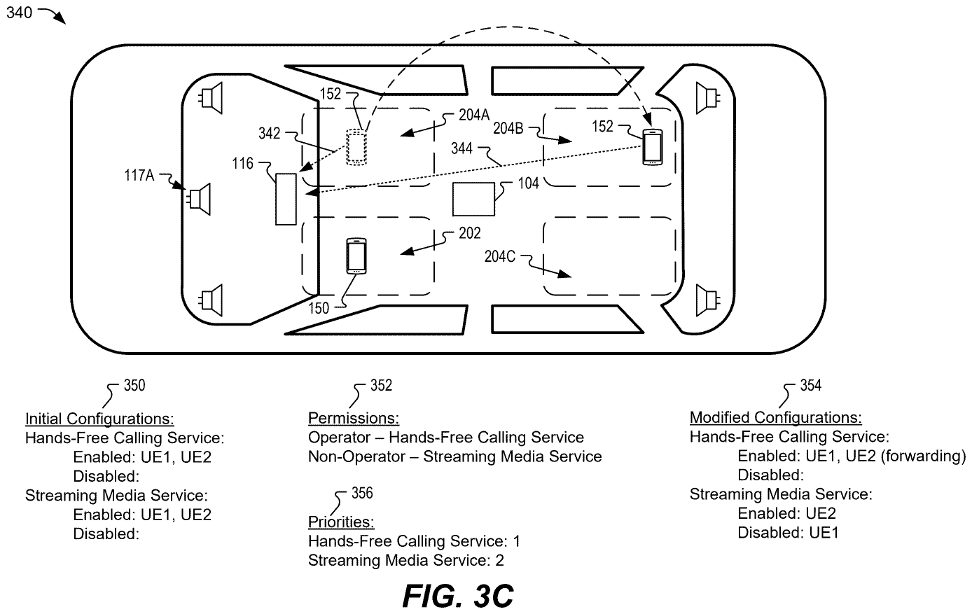

The classification selector 122 is configured to identify user classes associated with UEs based on relative positions of the UEs with respect to the vehicle. For example, the classification selector 122 may identify a first user class, associated with the UE 150 and represented by first class data 134, based on the first position data 130. Additionally, the classification selector 122 may identify a second user class, associated with the UE 152 and represented by second class data 136, based on the second position data 132. The classification selector 122 is configured to identify the user classes without profile configuration (e.g., that indicates user classes) and without receiving instructions from the UEs 150, 152. For example, unlike infotainment systems in which users configure the system to interact in particular ways with various UEs or assign classes or priorities to the UEs, the device 102 (e.g., the classification selector 122) identifies the user classes associated with the UEs 150, 152 independently of any manual configuration by a user. The user classes may be identified from a group of user classes that includes operator, non-operator occupant, child, front row, middle row, back row, infotainment adjacent, infotainment distant, other classes, or a combination thereof. In some embodiments, the classification selector 122 is configured to map direction or ranging information represented by the respective UE position to a corresponding position in the interior of the vehicle, as represented by vehicle interior data 126 that is generated by the classification selector 122, to identify the respective user classes. For example, the vehicle interior data 126 may represent or indicate the various regions defined for the interior of the vehicle, as well as associations between the regions and respective user classes. Although depicted in FIG. 1 as being included in the classification selector 122, the vehicle interior data 126 may also or in the alternative be stored in the memory 106. Examples of determining relative positions of UEs relative to a vehicle and identifying associated user classes is further described herein with reference to FIGS. 3A-3C.

The identified user classes are associated with respective permissions 111 for one or more media services associated with the media service configurations 110. For example, an operator class may have first priority (e.g., high priority) permissions for a first media service and second permissions (e.g., low priority) for a second media service, while an occupant class (e.g., a non-operator occupant class) may have the second permissions for the first media service and the first permissions for the second media service. In some embodiments, the permissions 111 correspond to priority of audio playout via the speakers 117, priority of video or multimedia playout via the display device 116, or a combination thereof.

The output selector 124 is configured to selectively enable playout of media, via the speakers 117, the display device 116, or a combination thereof, based on the permissions 111 associated with the identified user classes. Examples described herein are described in the context of enabling and controlling playout of audio via the speakers 117, but the concepts and examples described herein may also enable the device 102 to control playout of video or other visual media content via the display device 116. As an illustrative example, the output selector 124 may select a media service to support for audio playout at the speakers 117 based on requests for the media service included in the received data 140, 142, a priority associated with the media service with respect to other media services, and the permissions 111 associated with the media service for the UEs 150, 152 (as indicated by the first class data 134 and the second class data 136). Audio generated by the selected media service, as controlled by the UE 150 or the UE 152 (depending on which UE is associated with higher ranked permissions) is output by the media selection circuitry 120 (e.g., the output selector 124) as output data 138 that is provided to the speakers 117 (e.g., if the output data 138 includes audio data). Additionally, if visual data (e.g., image data, video data, or multimedia data) is generated by the selected media service, the output data 138 is also provided to the display device 116.

As a particular example in which the vehicle is a car, if a user of the UE 150 is seated in a passenger seat (e.g., a non-operator occupant position) such that the UE 150 is positioned within a non-operator occupant region, the device 102 may automatically reject a hands-free calling service connection from the UE 150 by rejecting (e.g., not accepting) a service-level connection for the hands-free calling service (e.g., a connection request that complies with a Bluetooth radio frequency communication (RFCOMM) protocol). As another example, if the user of the UE 150 is seated in the driver's seat (e.g., an operator position) such that the UE 150 is positioned within an operator region, the device 102 may automatically reject an audio streaming service connection (e.g., an advanced audio distribution profile (A2DP) connection) from the UE 150 by rejecting a service-level connection from the audio streaming service (e.g., a connection request that complies with a logical link control and adaption protocol (L2CAP) for either audio/video remote control profile (AVRCP) streaming or audio/video distribution transport protocol (AVDTP) streaming). As another example, if the UE 150 is positioned within the operator region, the device 102 may automatically reject an audio streaming service connection from the UE 150 by rejecting a Bluetooth low energy Audio (LEA) audio stream endpoint (ASE) enable request if a value of a context field in the ASE enable request indicates the streaming media service. As another example, if the UE 150 is positioned within the non-operator occupant region, the device 102 may automatically reject a hands-free calling service connection from the UE 150 by rejecting the ASE enable request if a value of the context field in the ASE enable request indicates the hands-free calling service Rejecting requests, or disconnecting an existing service-level connection, can be determined by the device 102 based on overall connected UEs 150, 152 and the respective relative positions (e.g., the classes identified based on the relative positions).

In embodiments that include the input device 114, the input device 114 is configured to receive an input and provide the input to the processor 108 as input data. For example, the input device 114 may include a keyboard, a touch screen, or a microphone configured to receive the input and provide the input data (e.g., an input signal) to the processor 108. The input data may indicate a command associated with playing out media content, such as pausing the playout, changing a volume, changing a setting, or the like. Additionally, or alternatively, the input device 114 may include or correspond to one or more microphones configured to receive one or more input audio signals associated with at least one of the one or more media services associated with the media service configurations 110.

In embodiments that include the display device 116, the display device 116 is coupled to the processor 108 and is configured to output media content, such as video content, that is streamed from the UEs 150, 152 (e.g., the output data 138). In some examples, the display device 116 includes a display screen, a monitor, an integrated infotainment display, or a combination thereof. The speakers 117 are coupled to the processor 108 and configured to output audio associated with media content that is streamed from the UEs 150, 152 (e.g., the output data 138). For example, if audio associated with a hands-free phone call is selected by the output selector 124, the speakers 117 output the audio corresponding to the hands-free phone call. As another example, if audio associated with a music streaming service is selected by the output selector 124, audio representing the music being streamed from one of the UEs 150, 152 is output by the speakers 117.

In embodiments that include the modem 118, the modem 118 is coupled to the processor 108 and is configured to receive connection requests and/or streaming media content from the UE 150, the UE 152, or both, for output by the device 102. For example, the modem 118 may be configured to receive a connection request that complies with a logical link control and adaption protocol (L2CAP)and associated with a media service, as further described herein. Additionally, or alternatively, the modem 118 is configured to access a server or another storage device to retrieve the media service configurations 110.

The wireless interface 104, the input device 114, the display device 116, the speakers 117, the modem 118, or a combination thereof may be coupled to or integrated within the device 102. Although the device 102 is described as being coupled to or including the wireless interface 104, the input device 114, the display device 116, the speakers 117, and the modem 118, in other embodiments, one or more of these elements are optional, and in such embodiments, the device 102 may not include or be coupled to the wireless interface 104, the input device 114, the display device 116, the speakers 117, the modem 118, or a combination thereof.

During operation of the system 100, the wireless interface 104 receives the sets of messages 154, 156 from the UEs 150, 152, respectively. The received messages may be provided as the received data 140, 142 that represents the sets of messages 154, 156, respectively, as input data to the media selection circuitry 120 (e.g., the position calculator 121 and the output selector 124). In some examples, the first set of messages 154 include one or more requests from the UE 150 that are associated with one or more media services, and the second set of messages 156 include one or more requests from the UE 152 that are associated with one or more media services. The position calculator 121 performs wireless positioning operations based on the first received data 140 and the second received data 142 to determine the first position data 130 and the second position data 132, respectively.

The classification selector 122 generates the first class data 134 and the second class data 136 that indicates a class associated with the UE 150 and a class associated with the UE 152, respectively. The classes are identified without being preconfigured or set by the UEs 150, 152. In a particular example, the first class data 134 indicates that the UE 150 is associated with an operator class (e.g., based on the relative position of the UE 150 being within an operator position) and the second class data 136 indicates that the UE 152 is associated with a non-operator occupant class (e.g., based on the relative position of the UE 152 being within an occupant position). The output selector 124 selectively enables playout of audio at the speakers 117 by generating the output data 138 based on the first class data 134, the second class data 136, the first received data 140, the second received data 142, and the media service configurations 110 (including the permissions 111).

In a first example, the first received data 140 indicates a request associated with the hands-free calling service from the UE 150, and the second received data 142 indicates a request associated with the hands-free calling service from the UE 152. In this example, the operator class is associated with the permissions 111 for the hands-free calling service that have a higher priority than the permissions 111 for the hands-free calling service associated with the non-operator occupant class. Accordingly, the output selector 124 may initiate a hands-free calling session with the UE 150, due to the first class data 134 indicating that the UE 150 is associated with the operator class, and the output data 138 that is provided for playout at the speakers 117 corresponds to the hands-free calling session between the device 102 and the UE 150.

In another example, the first received data 140 indicates a request associated with the audio streaming service from the UE 150, and the second received data 142 indicates a request associated with the audio streaming service from the UE 152. In this example, the operator class is associated with the permissions 111 for the audio streaming service that have a lower priority than the permissions 111 for the audio streaming service associated with the non-operator occupant class. Accordingly, the output selector 124 may initiate an audio streaming session with the UE 152, due to the second class data 136 indicating that the UE 152 is associated with the non-operator occupant class, and the output data 138 that is provided for playout at the speakers 117 corresponds to the audio streaming session between the device 102 and the UE 152. In this example, if the device 102 receives a request associated with the hands-free calling service from the UE 150, the output selector 124 may pause the audio streaming session with the UE 152 to enable a hands-free calling session with the UE 150 (e.g., if the hands-free calling permissions of the operator class have a higher priority than the audio streaming service permissions of the non-operator occupant class).

In some embodiments, the media selection circuitry 120 (e.g., the position calculator 121 and the classification selector 122) determines the relative positions and classes associated with the UEs 150, 152 at startup of the vehicle or when the UEs 150, 152 are communicatively coupled to the device 102. In some other embodiments, the position determination and user class identification are performed multiple times, such as based on detection of a trigger condition or according to a preconfigured schedule. The preconfigured schedule may be a periodic schedule or a user-configured schedule. The trigger condition may include an opening of a door of the vehicle, the vehicle being configured in a stationary mode, a change in a power state of the vehicle, or a combination thereof.

In some embodiments, the trigger condition is detected during operation of, and travel by, the vehicle. In an example, based on detection of the trigger condition or according to the preconfigured schedule, the position calculator 121 performs one or more additional wireless positioning operations with respect to the UE 150 to determine an updated relative position of the UE 150 with respect to the interior of the vehicle. In this example, the classification selector 122 determines whether an updated user class, that is different from the previously identified user class, is associated with the UE 150 based on the updated relative position of the UE 150, and, based on the updated user class being different from the user class, the output selector 124 selectively enables playout of the audio based on updated permissions associated with the updated user class. To illustrate, if the vehicle is stopped and the occupants exit and re-enter the vehicle in different positions, such that the UE 152 is now located in the operator position and the UE 150 is now located in the non-operator occupant position, the position calculator 121 may determine updated positions of the UE 150, 152 that result in updated classification of the UEs 150, 152 as non-operator occupant and operator, respectively. In this example, based on the updated classes, the output selector 124 may enable an audio streaming session with the UE 150 or a hands-free calling session with the UE 152 based on received requests. Additional details of examples of determining and updating user classes and selecting associated outputs are further described herein with reference to FIGS. 3A-3C.

In some examples, the device 102 corresponds to or is included in one of various types of devices, such that the processor 108 can be integrated in multiple types of devices. In an illustrative example, the processor 108 is integrated in a mobile device (a mobile phone or a tablet) as depicted in FIG. 6 or a vehicle as depicted in FIGS. 7-9, a computer or a server, or another system or device. In some examples, the device 102 includes a memory (e.g., the memory 106) configured to store configurations (e.g., the media service configurations 110) of a plurality of media services. The configurations are associated with one or more UEs (e.g., the UEs 150, 152). The device also includes one or more processors (e.g., the processor 108) coupled to the memory. The one or more processors are configured to perform one or more wireless positioning operations to determine a relative position (e.g., indicated by the first position data 130) of a UE (e.g., the UE 150) of the one or more UEs with respect to an interior of a vehicle. The one or more processors are also configured to identify a user class (e.g., indicated by the first class data 134) associated with the UE based on the relative position of the UE, The user class is associated with permissions (e.g., the permissions 111) for one or more media services of the plurality of media services. The one or more processors are also configured to modify, based on the permissions, a set of configurations (e.g., the media service configurations 110) that are associated with the one or more media services and the UE. The one or more processors are also configured to selectively enable playout of audio (e.g., corresponding to the output data 138), via one or more speakers (e.g., the speakers 117), based on the modified set of configurations.

One technical advantage of implementing the device 102 as described above is that the device 102 performs intelligent selection of media playout based on relative positions of the UEs 150, 152 without requiring configuring by users of the device 102 or the UEs 150, 152. For example, by automatically selecting between playout of audio associated with either a hands-free calling service and an audio streaming service requested by the UEs 150, 152, respectively, the device 102 can provide a seamless media experience that also increases safety of the operator and the non-operators of a vehicle. To illustrate, without requiring manual configuration by the operator, the media selection circuitry 120 may generate the output data 138 based on audio of a hands-free calling service requested by the UE 150 based on a determination that the UE 150 is located within an operator region of the vehicle (and that the hands-free calling service has a higher priority than a streaming media service as indicated by the permissions 111). Providing this automatic, intelligent selection of output media reduces operator distraction by obviating the need for the operator to select a service to be supported by the device 102 and by associating lower priority and more distracting services, like a streaming media service, with UEs that are located in non-operator regions, so that the operator is not distracted interacting with such services while operating the vehicle.

FIG. 2 is a diagram of an example in which the device 102 of FIG. 1 is integrated in or included in a vehicle 200, in accordance with one or more aspects of the present disclosure. For example, the device 102 may include one or more components of the vehicle 200, such as an infotainment system of the vehicle 200, or the device 102 may be the vehicle 200 itself. Although the vehicle 200 is depicted as a car in FIG. 2, in other embodiments, the vehicle 200 may include a different type of land craft, an aircraft, or a water craft, as described further herein with reference to FIGS. 7-9. The vehicle 200 is configured to support the media services associated with the media service configurations 110 and to perform the operations described above with respect to the device 102. For example, the vehicle 200 includes the wireless interface 104, the display device 116, and speakers 117A, 117B, 117C, 117D, and 117E, that operate as described with reference to FIG. 1. The wireless interface 104, the display device 116, and the speakers 117 may be included in, correspond to, or be distributed components of a single system, such as an infotainment system, of the vehicle 200.

Although a single wireless interface 104, a single display device 116, and five speakers 117A-117E are depicted in FIG. 2, in other embodiments, the vehicle 200 may include more than one wireless interface 104, more than one display device 116, fewer than five or more than five speakers 117, or a combination thereof. As an illustrative example, the vehicle 200 may include multiple wireless interfaces 104 at various positions, which may include or correspond to UWB enabled nodes, BT transceivers, wireless radios, or the like. Additionally, or alternatively, relative positions of the wireless interface 104, the display device 116, the speakers 117A-117E, or a combination thereof, within the vehicle 200 may be different than illustrated in FIG. 2.

An interior of the vehicle 200 may be divided into multiple different regions, such as based on proximity of expected occupants of the vehicle, proximity of particular components or elements of the vehicle 200 or the infotainment system, or other considerations. In the example shown in FIG. 2, the regions defined for the interior of the vehicle 200 include an operator region 202 (e.g., a region near a steering wheel or other controls of the vehicle 200), a non-operator occupant region 204A (e.g., a region near a front passenger seat or other area in a front portion of the vehicle 200 away from the steering wheel or controls), a non-operator occupant region 204B (e.g., a region near a back passenger-side passenger seat or other area in a back portion of the vehicle 200 away from the steering wheel or controls), and a non-operator occupant region 204C (e.g., a region near a back driver-side passenger seat or other area in a back portion of the vehicle 200 away from the steering wheel or controls). Although four regions 202 and 204A-204C are shown in FIG. 2, in other embodiments, the interior of the vehicle 200 may include fewer than four or more than four regions that are defined for the purpose of determining user classes associated with UEs positioned within the respective regions. The definition of the various regions 202 and 204A-204C may be represented by the vehicle interior data 126 of FIG. 1.

Each of the regions 202 and 204A-204C are associated with a respective user class. For example, the operator region 202 may be associated with an operator class (e.g., a driver class), and the non-operator occupant regions 204A-204C may be associated with a non-operator occupant class (e.g., a passenger class). In other embodiments, other classes may be associated with the regions 202 and 204A-204C, or with other defined regions. As one example, an infotainment operator class may be associated with the non-operator occupant region 204A, and a back-row occupant class may be associated with the non-operator occupant regions 204B and 204C. Detection of UE positions within the regions 202 and 204A-204C may cause identification of respective user classes for use in determining media content to be played out via the display device 116, one or more of the speakers 117A-117E, or a combination thereof, as further described with reference to FIGS. 3A-3C. Additionally, or alternatively, media (e.g., audio) playout by the speakers 117A-117E may be based on proximity to one or more of the speakers 117A-117E. As an illustrative example, after selecting which media service from which audio is to be played out, the vehicle 200 may select to playout the audio via one or more of the speakers that are proximate to a region in which a UE is positioned, such as by causing the speakers 117D and 117E to playout audio based on a UE being detected in the non-operator occupant region 204B. In other embodiments, the speakers 117A-117E may not be individually controlled and instead may be controlled as a group with respect to selection of audio for playout.

FIGS. 3A-3C are diagrams of examples of operations associated with media configuration and playout based on positioning that are performed by the vehicle 200 of FIG. 2, in accordance with one or more aspects of the present disclosure. FIG. 3A illustrates a first example 300 of modifying media service configurations based on user classes that are determined based on relative positions of UEs within the vehicle 200. FIG. 3B illustrates a second example 320 of modifying media service configurations based on user classes that are determined based on relative positions of UEs within the vehicle 200. FIG. 3C illustrates a third example 340 of modifying media service configurations based on user classes that are determined based on relative positions of UEs within the vehicle 200. In the examples shown in FIGS. 3A-3C, the vehicle 200 includes the wireless interface 104, the display device 116, and the speakers 117 (e.g., the speakers 117A-117E). Additionally, the UEs 150, 152 are located at various positions within the interior of the vehicle 200.

In the first example 300 shown in FIG. 3A, each of the UE 150 and the UE 152 may initially be configured to access both a hands-free calling service and a streaming media service, as indicated by initial configurations 310. The wireless interface 104 may facilitate performance of one or more wireless positioning operations by the position calculator 121 to enable determination of a relative position of the UE 150 and the UE 152 with respect to the interior of the vehicle 200. For example, based on wireless ranging operations, direction operations, or channel sounding operations, a relative position of the UE 150 may be determined as being within the operator region 202 and a relative position of the UE 152 may be determined as being with the non-operator occupant region 204A. The classification selector 122 may identify a user class associated with the UE 150 as an operator class (e.g., based on the UE 150 being within the operator region 202) and a user class associated with the UE 152 as a non-operator occupant class (e.g., based on the UE 152 being within the non-operator occupant region 204A). As indicated by the permissions 312, the operator class may be associated with permissions for the hands-free calling service and the non-operator class may be associated with permissions for the streaming media service. Additionally, as indicated by the priorities 316, the hands-free calling service has a higher priority (e.g., a priority value ‘1’) than a priority (e.g., a priority value ‘2’) of the streaming media service.

The output selector 124 may modify, based on the permissions 312 and the positions of the UEs 150 and 152, the initial configurations 310 to generate modified configurations 314. In an illustrative example, the output selector 124 may identify a difference between permissions associated with a user class associated with the UE 150 based on the position and one or more of the initial configurations 310 associated with the UE 150. In this example, the output selector 124 may change one or more of the initial configurations 310 from a first state to a second state based on the identified difference, such as by changing a respective configuration state from enabling access to denying access or from denying access to enabling access. To illustrate, to generate the modified configurations 314, the enabled state for the streaming media service associated with the UE 150 may be changed to the disabled state based on the UE 150 being within the operator region 202, which corresponds to the operator class that has permissions for the hands-free calling service but not for the streaming media service. Similarly, the enabled state for the hands-free calling service associated with the UE 152 may be changed to the disabled state based on the UE 152 being within the non-operator occupant region 204A, which corresponds to the non-operator occupant class that has permissions for the streaming media service but not for the hands-free calling service.

The output selector 124 may selectively enable playout of audio, via one or more speakers 117, based on the modified configurations 314, such as by accepting or rejecting requests associated with the various media content services from the UEs 150, 152. As an example, the vehicle 200 may receive a first request 302 associated with the hands-free calling service from the UE 150 and a second request 306 associated with the hands-free calling service from the UE 152. The requests 302, 306 may be received simultaneously or concurrently, or one of the requests 302, 306 may be received while the vehicle 200 is playing out audio associated with the other of the requests 302, 306. Thus, requests referred to herein as being received “from both UEs” or “at the same time” may refer to requests that are received concurrently or to a second request that is received during playout of audio associated with a first request. Because the modified configurations 314 indicate that the hands-free calling service is enabled for the UE 150 and not for the UE 152, the vehicle 200 may initiate a hands-free calling session with the UE 150 (e.g., based on the first request 302), and the output data 138 that is provided for playout by the speakers 117 may correspond to audio of the hands-free calling session. In this example, the hands-free calling session associated with the second request 306 from the UE 152 is denied. Prioritizing the operator of the vehicle 200 for hands-free calling sessions may provide fewer distractions for the operator than if the operator is required to accept a phone call without using the hands-free calling service or to manually configure the infotainment system, thereby increasing occupant safety.

As another example, the vehicle 200 may receive a third request 304 associated with the audio streaming service from the UE 150 and a fourth request 308 associated with the audio streaming service from the UE 152. Because the modified configurations 314 indicate that the streaming media service is enabled for the UE 152 and not for the UE 150, the vehicle 200 may initiate a streaming media session with the UE 152 (e.g., based on the fourth request 308), and the output data 138 that is provided for playout by the speakers 117 may correspond to audio of the streaming media session. In this example, the streaming media session associated with the third request 304 from the UE 150 is denied. Preventing the operator of the vehicle 200 from having access to the streaming media service during operation of the vehicle 200 may reduce distractions for the operator, thereby increasing occupant safety while still providing a seamless audio experience based on control by a non-operator occupant.

In some examples, the vehicle 200 may detect which requests to enable and reject based on communication protocols associated with the respective requests. In some embodiments, hands-free calling service requests and media content may be associated with a Bluetooth radio frequency communication (RFCOMM) protocol, and streaming media service requests and media content may be associated with an advanced audio distribution profile (A2DP) connection, such as a connection request that complies with a logical link control and adaption protocol (L2CAP) for either audio/video remote control profile (AVRCP) streaming or audio/video distribution transport protocol (AVDTP) streaming. Additionally, or alternatively, both the hands-free calling service requests and the streaming media service requests may be associated with ASE enable requests, and a context field within the ASE enable requests may indicate or correspond to either the hands-free calling service or the streaming media service.

The vehicle 200 may accept or deny requests associated with particular protocols based on the modified configurations 314. For example, if the UE 150 is detected within the operator region 202, the vehicle 200 may automatically accept the first request 302 (e.g., an RFCOMM request from the UE 150 associated with the hands-free calling service or an ASE enable request in which the context field indicates the hands-free calling service) and automatically reject the third request 304 (e.g., an L2CAP connection from the UE 150 associated with the streaming media service). Additionally, the vehicle 200 may automatically reject the second request 306 (e.g., an RFCOMM request from the UE 152 associated with the hands-free calling service) and may automatically accept the fourth request 308 (e.g., an L2CAP request from the UE 152 associated with the streaming media service or an ASE enable request in which the context field indicates the streaming media service) if no other higher priority request is received at the same time (e.g., if the hands-free calling service session is completed). Although described as accepting and rejecting requests, the vehicle 200 (e.g., the device 102) may connect, maintain, or disconnect an existing service-level connection in the same manner.

In the second example 320 shown in FIG. 3B that takes place after the first example 300 shown in FIG. 3A, the UE 150 is initially configured to access the hands-free calling service but not the streaming media service, and the UE 152 is initially configured to access the streaming media service but not the hands-free calling service as indicated by initial configurations 330. In the second example 320, the UE 152 is within the operator region 202 and the UE 150 is within the non-operator occupant region 204A, and therefore the UE 150 is identified as being in the non-operator occupant class and the UE 152 is identified as being in the operator class. As indicated by the permissions 332, the operator class may be associated with permissions for the hands-free calling service and the non-operator class may be associated with permissions for the streaming media service. Additionally, as indicated by the priorities 336, the hands-free calling service has a higher priority (e.g., a priority value ‘1’) than a priority (e.g., a priority value ‘2’) of the streaming media service.

The initial configurations 330 may be modified, based on the permissions 332 and the positions of the UEs 150 and 152, to generate modified configurations 334. For example, to generate the modified configurations 334, the enabled state for the hands-free calling service associated with the UE 150 may be changed to the disabled state and the disabled state for the streaming media service may be changed to the enabled state based on the UE 150 being within the non-operator occupant region 204A, which corresponds to the non-operator occupant class that has permissions for the streaming media service but not for the hands-free calling service. Similarly, the enabled state for the streaming media service associated with the UE 152 may be changed to the disabled state and the disabled state for the hands-free calling service may be changed to the enabled state based on the UE 152 being within the operator region 202, which corresponds to the operator class that has permissions for the hands-free calling service but not for the streaming media service.

In the second example 320, the vehicle 200 may receive a first request 322 that is associated with the hands-free calling service from the UE 152 and a second request 324 from the UE 150 that is associated with the hands-free calling service. Based on the UE 150 being a member of the non-operator occupant class, the vehicle 200 may automatically reject (e.g., not accept) the second request 324 (e.g., a connection request that complies with the Bluetooth RFCOMM protocol) from the UE 150. Additionally, based on the UE 152 being a member of the operator class, the vehicle 200 may automatically accept the first request 322 (e.g., a connection request that complies with the Bluetooth RFCOMM protocol) from the UE 152. In this manner, when a UE changes relative position within the interior of the vehicle 200, the vehicle 200 (e.g., the device 102) may automatically update the configurations associated with the media services to indicate any changed UE permissions based on changes to the user classes of the respective UEs.

The second example 320 represents a time after the first example 300 of FIG. 3A. In some implementations, the vehicle 200 (e.g., the device 102) is configured to detect positions of the UEs 150, 152 using the wireless positioning operations multiple times during operation of the vehicle 200. For example, the vehicle may detect updated positions of the UEs 150, 152 periodically, such as according to a preconfigured schedule, or based on detection of a trigger condition. The trigger condition may include an opening of a door of the vehicle 200, the vehicle 200 being configured in a stationary mode, a change in a power state of the vehicle 200, or a combination thereof. As an illustrative example, in response to detecting that one or more doors of the vehicle 200 opened and then closed, which may be due to the users of the UEs 150, 152 stopping to change the operator of the vehicle 200, the vehicle 200 may perform the operations described with reference to the second example 320 of FIG. 3B. In this example, the user of the UE 150 has moved from the operator region 202 to the non-operator occupant region 204A and the user of the UE 152 has moved from the non-operator occupant region 204A to the operator region 202 to begin operating the vehicle 200, and accordingly, the modified configurations 334 indicate the changes to the configurations of the hands-free calling service and the streaming media service for the UEs 150, 152 based on the changes in position.

In the third example 340 shown in FIG. 3C, each of the UE 150 and the UE 152 may initially be configured to access both a hands-free calling service and a streaming media service, as indicated by initial configurations 350. In the third example 340, the UE 150 is within the operator region 202 and the UE 152 is initially within the non-operator occupant region 204A, and therefore the UE 152 is identified as being in the non-operator occupant class and the UE 150 is identified as being in the operator class. As indicated by the permissions 352, the operator class may be associated with permissions for the hands-free calling service and the non-operator class may be associated with permissions for the streaming media service. Additionally, as indicated by the priorities 356, the hands-free calling service has a higher priority (e.g., a priority value ‘1’) than a priority (e.g., a priority value ‘2’) of the streaming media service.

The initial configurations 350 may be modified, based on the permissions 352 and the positions of the UEs 150 and 152, to generate modified configurations 354. For example, to generate the modified configurations 354, the enabled state for the streaming media service associated with the UE 150 may be changed to the disabled state based on the UE 150 being within the operator region 202, which corresponds to the operator class that has permissions for the hands-free calling service but not for the streaming media service. Additionally, the enabled state for the hands-free calling service associated with the UE 152 may be changed to a forwarding state based on the UE 152 being within the non-operator occupant region 204A, which corresponds to the non-operator occupant class that has full permissions for the streaming media service but only call forwarding permissions for the hands-free calling service.

In the example 340 of FIG. 3C, call forwarding permissions correspond to a capability for a UE to have the hands-free calling service enabled in situations in which the UE is unable to answer an incoming call, but not when the UE is in situations in which the UE is able to answer the incoming call. To illustrate, at a first time the UE 152 is within the non-operator occupant region 204A, and the vehicle 200 receives a first request 342 from the UE 152 that is associated with the hands-free calling service. Because the UE 152 has call forwarding permissions to the hands-free calling service, the vehicle 200 determines whether the UE is in a call forwarding state. The call forwarding state may be detected based on one or more conditions, such as the UE 152 moving from one region to another during operation of the vehicle 200, the UE 152 being set in a call forwarding mode, the UE 152 executing one or more applications associated with a child or other entity that is not an owner of the UE 152, or another condition that indicates that the UE 152 is no longer in the possession of the recipient of an incoming call. At the first time, the vehicle 200 detects that the UE 152 has remained in the non-operator occupant region 204A since the vehicle 200 was started and that no other condition indicates that the UE 152 is in a call forwarding situation, and thus the vehicle 200 rejects the first request 342 and does not output audio associated with the hands-free calling service from the UE 152 via the speakers 117.

At a later time, the user of the UE 152 hands the UE 152 to a person in within the non-operator occupant region 204B (e.g., a back seat), such as a child. At a second time after the UE 152 has changed position, an incoming call is received at the UE 152 and the vehicle 200 receives a second request 344 from the UE 152 associated with the hands-free calling service. At the second time, the vehicle 200 detects that the UE 152 is now in a call forwarding situation. For example, the vehicle 200 may determine that the UE 152 is in the call forwarding situation based on the UE 152 having moved between the non-operator occupant region 204A and the non-operator occupant region 204B during operation of the vehicle 200 or based on the user changing a setting of the UE 152 to a call-forwarding mode before the user handed the UE 152 to the person in the non-operator occupant region 204B. Based on detection of the call forwarding situation, the vehicle 200 accepts the second request 344 at the second time and outputs audio associated with the hands-free calling service from the UE 152 via the speakers 117, so that the owner of the UE 152 (e.g., a parent sitting in the non-operator occupant region 204A), can conduct the call via the infotainment system of the vehicle 200 while the UE 152 is in the non-operator occupant region 204B (e.g., a child has the UE 152 in the back seat).

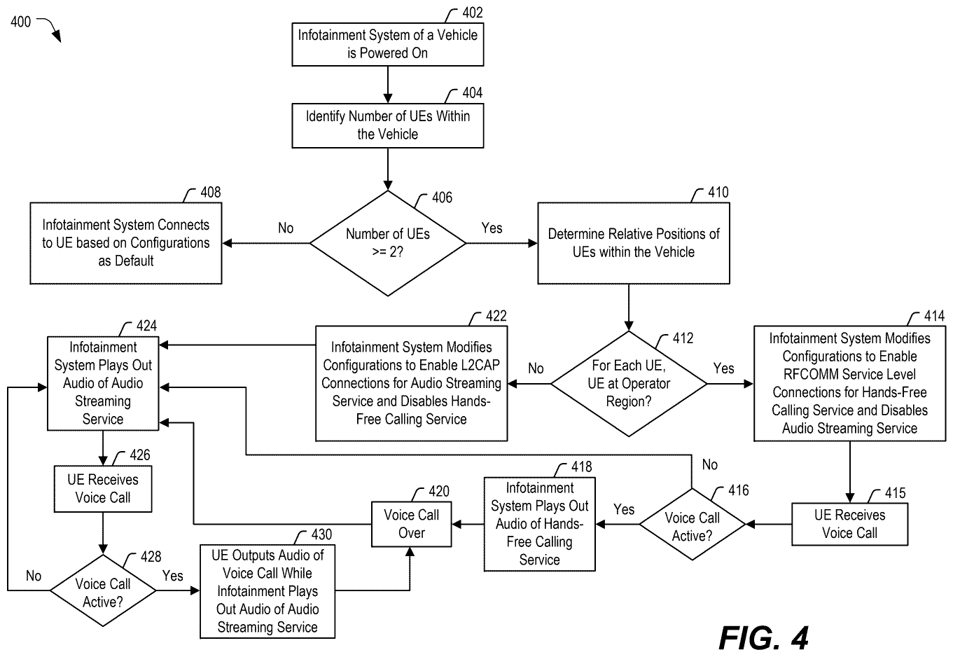

FIG. 4 is a diagram of an example process 400 for modifying media configurations and selectively playing out media based on positioning, in accordance with one or more aspects of the present disclosure. Operations of the process 400 may be performed by one or more of the wireless interface 104, the processor 108, the media selection circuitry 120, the position calculator 121, the classification selector 122, the output selector 124, the device 102, the system 100 of FIG. 1, or the vehicle 200 of FIGS. 2-3C.

The process 400 begins at 402, and an infotainment system of a vehicle is powered on. The infotainment system may include or correspond to the device 102 of FIG. 1 or may be configured to perform the operations described with reference to the vehicle 200 in FIGS. 2-3C. At 404, a number of UEs within the vehicle are identified. In the examples shown in FIGS. 2-3C, the two UEs 150, 152 are identified. At 406, the infotainment system determines whether the number of identified UEs is greater than or equal to two. If the number of UEs is less than two (e.g., a single UE is detected), the process continues to 408, and the infotainment system connects to the identified UE based on default configurations associated with the UE and one or more services supported by the infotainment system, such as a hands-free calling service and a streaming media service (e.g., an audio streaming service).

Returning to 406, if the number of identified UEs is greater than or equal to two (e.g., multiple UEs are identified), the process 400 proceeds to 410, and the infotainment system determines relative positions of the multiple UEs within the vehicle. For example, the infotainment system may perform one or more wireless positioning operations with respect to the UEs to determine relative positions of the UEs within an interior of the vehicle. In some examples, the relative positions correspond to presence within one of multiple defined regions within the vehicle, such as the operator region 202 and the non-operator occupant regions 204A-204C of FIG. 2.

At 412, the infotainment system determines, for each identified UE, whether the UE is within the operator region (or a different type of region configured with similar permissions). For example, the infotainment system may compare the relative position of the UEs to a region defined as the operator region within the vehicle, and if the relative position of a UE is within the defined region (e.g., if a distance and direction of the UE is within respective distance and direction ranges), the UE is determined to be positioned within the operator region. If a UE is determined to be within the operator region, the process 400 continues to 414, and the infotainment system modifies configurations to enable RFCOMM service level connections for a hands-free calling service (or ASE enable requests in which the context field indicates the streaming media service) and disables L2CAP connections for an audio streaming service (or ASE enable requests in which the context field indicates the audio streaming service). For example, the infotainment system may generate the modified configurations 314 associated with the UE 150 as described above with reference to FIG. 3A.

At 415, the UE in the operator region receives a voice call, and at 416, the infotainment system determines if the voice call is active (e.g., if the voice call is accepted by a user). For example, the user may press a button on a screen of the infotainment system or a button on a steering wheel to accept (e.g., activate) the voice call. If the voice call is accepted (e.g., active), the process 400 continues to 418, and the infotainment system plays out audio of the hands-free calling service from the UE. For example, the output data 138 may include audio of the hands-free calling service from the UE 150, and the output data may cause the speakers 117 to output audio of the voice call. At 420, the voice call ends, and at 424, the infotainment system plays out audio of the audio streaming service from a UE that is not within the operator region. For example, because the hands-free calling service may have higher priority than the audio streaming service, the infotainment system may prioritize playing out audio from the hands-free calling service over audio from the audio streaming service if both services are requested at the same time (or if a second request is received while audio is being played out in response to a first request). Returning to 416, if the voice call is not accepted (e.g., is not active, such as if the user declines to accept the voice call), the process 400 proceeds to 424, and the infotainment system plays out audio of the audio streaming service from a UE that is not within the operator region.

Returning to 412, if a UE is determined to be in a different region than the operator region (e.g., a non-operator occupant region or another region with similar priorities for the various services supported by the infotainment system), the process 400 proceeds to 422 and the infotainment system modifies configurations to enable L2CAP connections for the audio streaming service (or ASE enable requests in which the context field indicates the audio streaming service) and disables RFCOMM service level connections for the hands-free calling service (or ASE enable requests in which the context field indicates the hands-free calling service) for the UE that is not within the operator region. For example, the infotainment system may generate the modified configurations 314 associated with the UE 152 as described above with reference to FIG. 3A. The process continues to 424, and the infotainment system plays out audio of the audio streaming service from the UE that is not within the operator region.

The process 400 may continue to 426, and the UE in the non-operator occupant region receives a voice call during playout of the audio associated with the audio streaming service. At 428, the infotainment system determines if the voice call is active (e.g., if the voice call is accepted by the user) at the UE in the non-operator occupant region, and if the voice call is not active, the process 400 returns to 424 and the playout of the audio of the audio streaming service continues via the speakers 117. Alternatively, if the voice call is active, the process 400 progresses to 430, and the UE within the non-operator occupant region outputs audio associated with the voice call while the infotainment system continues to output audio associated with the audio streaming service. In some other embodiments, the infotainment system may pause output of audio while the UE performs the voice call. The process 400 proceeds to 420 and the voice call ends. After the voice call is over, the process 400 returns to 424, and audio of the audio streaming service is output by the infotainment system.

It is noted that although the services described in FIG. 4 are described with reference to particular communication protocols (e.g., the Bluetooth RFCOMM protocol, the L2CAP protocol, and the LEA protocol), in other embodiments, the hands-free calling service and the audio streaming service may communicate according to other communication protocols.

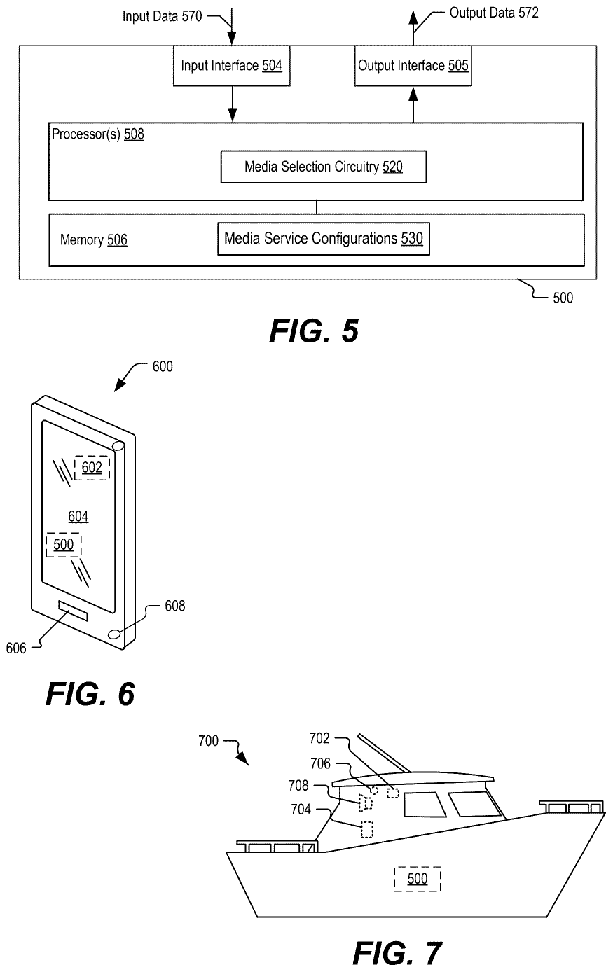

FIG. 5 depicts a diagram of an example of an integrated circuit 500 operable to support media configuration and playout based on positioning, in accordance with some examples of the present disclosure. The integrated circuit 500 includes one or more processors 508 (herein after referred to as the “processor 508”) and a memory 506. The processor 508 and the memory 506 may include or correspond to the processor 108 and the memory 106, respectively. The processor 508 may include media selection circuitry 520, and the memory 506 includes (e.g., stores) media service configurations 530. The media selection circuitry 520 may include or correspond to the media selection circuitry 120, and the media service configurations 530 may include or correspond to the media service configurations 110.

The integrated circuit 500 also includes an input interface 504, such as one or more bus interfaces, to enable the integrated circuit 500 to receive signals representing input data 570 for processing. For example, the input data 570 can correspond to or include the first received data 140, the second received data 142, input data from the input device 114, or a combination thereof.

The integrated circuit 500 also includes an output interface 505, such as a bus interface, to enable the integrated circuit 500 to output signals representing output data 572. For example, the output data 572 can correspond to or include the output data 138.

The integrated circuit 500 including the media selection circuitry 520 and the media service configurations 530 enables implementation of intelligent media configuration and playout in a system or a device. For example, the system or the device may include a mobile device (e.g., a mobile phone or tablet) as depicted in FIG. 6 or a vehicle as depicted in FIGS. 7-9.

In some embodiments, the system or the device that includes the integrated circuit 500 also includes or is coupled to an input device (e.g., a microphone, a keyboard or touch screen, etc.), a display device, a speaker, a modem, or a combination thereof. For example, the input device, the display device, the speaker, and the modem may include or correspond to the input device 114, the display device 116, the speaker 117, and the modem 118, respectively.

FIG. 6 depicts a diagram of a mobile device 600 operable to support media configuration and playout based on positioning, in accordance with some examples of the present disclosure. The mobile device 600 may include or correspond to a phone or a tablet, as illustrative, non-limiting examples. The mobile device 600 includes a wireless interface 602, a display 604 (e.g., a display screen), a microphone 606, a speaker 608, and the integrated circuit 500. Components of the integrated circuit 500, including the media selection circuitry 520, are integrated in the mobile device 600 and are illustrated using dashed lines to indicate internal components that are not generally visible to a user of the mobile device 600.

FIG. 7 is a diagram of a first example of a vehicle 700 operable to support media configuration and playout based on positioning, in accordance with some examples of the present disclosure. The vehicle 700 may include or correspond to a watercraft. The vehicle 700 includes a wireless interface 702, a display 704 (e.g., a display screen), a microphone 706, a speaker 708, and the integrated circuit 500. Components of the integrated circuit 500, including the media selection circuitry 520, are integrated in the vehicle 700 and are illustrated using dashed lines to indicate internal components that are not generally visible from the exterior the vehicle 700.

Although the vehicle 700 is illustrated in FIG. 7 as a boat, in other examples, the watercraft can include or correspond to a submersible, a ship, a barge, a ferry, or another type of watercraft. Further, the vehicle 700 can be crewed or uncrewed.

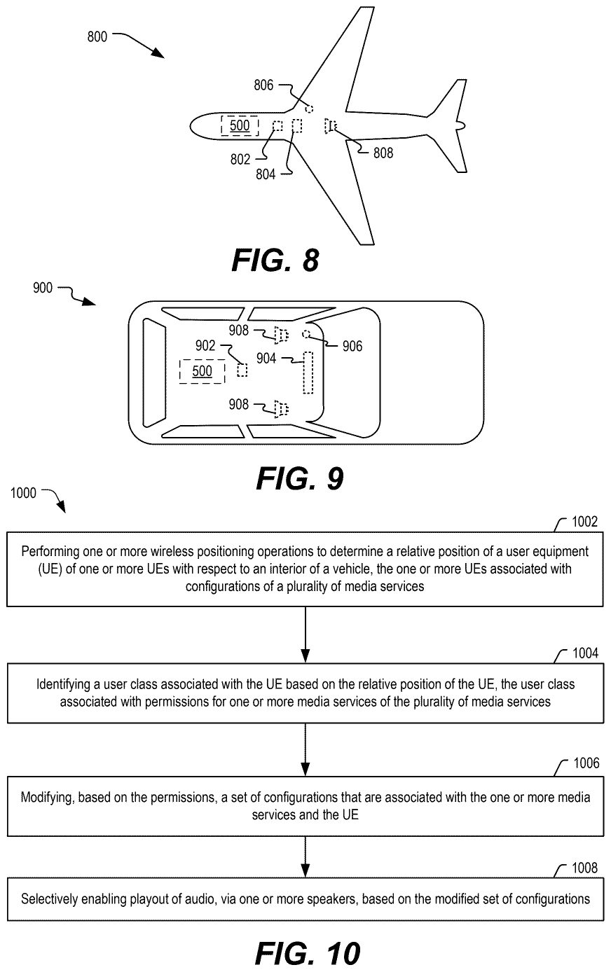

FIG. 8 is a diagram of a second example of a vehicle 800 operable to support media configuration and playout based on positioning, in accordance with some examples of the present disclosure. The vehicle 800 may include or correspond to an aircraft. The vehicle 800 includes a wireless interface 702, a display 804 (e.g., a display screen), a microphone 806, a speaker 808, and the integrated circuit 500. Components of the integrated circuit 500, including the media selection circuitry 520, are integrated in the vehicle 800 and are illustrated using dashed lines to indicate internal components that are not generally visible to from an exterior of the vehicle 800.

Although the vehicle 800 is illustrated in FIG. 8 as an airplane, in other examples, the aircraft can include or correspond to a fixed wing aircraft, a rotary wing aircraft, an aerostat, a hybrid aircraft, a helicopter, or another type of aircraft. In other examples, the vehicle 800 may include or correspond to a spacecraft. Further, the vehicle 800 can be crewed or uncrewed.

FIG. 9 is a diagram of a third example of a vehicle 900 operable to support media configuration and playout based on positioning, in accordance with some examples of the present disclosure. The vehicle 900 may include or correspond to a land craft, such as a car. The vehicle 900 includes a wireless interface 902, a display 904 (e.g., a display screen), a microphone 906, one or more speakers 908, and the integrated circuit 500. Components of the integrated circuit 500, including the media selection circuitry 520, are integrated in the vehicle 900 and are illustrated using dashed lines to indicate internal components that are not generally visible to a user of the vehicle 900.

Although the vehicle 900 is illustrated in FIG. 9 as a car, in other examples, the aircraft can include or correspond to another type of land craft, such as a truck. Further, the vehicle 900 can be crewed or uncrewed.

In a particular example, the media selection circuitry 520 is operable to obtain receive requests for streaming media service access by the mobile device 600 or the vehicles 700-900 and determine a relative position of one or more UEs within a vehicle using the wireless interfaces 602, 702, 802, or 902. The media selection circuitry 520 may also identify user classes associated with the one or more UEs based on the relative positions, modify the media service configurations 530 based on permissions associated with the user classes, and selectively enable playout of audio, via the speakers 608, 708, 808, or 908, based on the modified media service configurations 530. Intelligently selecting audio for playout based on relative position of UEs within the vehicle may improve occupant safety and provide a seamless audio experience.

The embodiments of the systems or devices as described with reference to FIGS. 6-9 are described, respectively, as including a display, a microphone, a speaker, a camera, or a combination thereof. As described with reference to FIGS. 6-9, the display, the microphone, and the speaker, may include or correspond to the display device 116, the input device 114, and the speaker 117, respectively. It is noted that in other embodiments of the systems or devices of FIGS. 6-9, one or more of the systems or devices of FIGS. 6-9 may not include the display, the microphone, the speaker, the camera, or a combination thereof. Additionally, or alternatively, one or more of the systems or devices of FIGS. 6-9 may include an additional component. For example, the additional component may include a modem, such as the modem 118.

FIG. 10 is a diagram of an example of a method 1000 of media configuration and playout based on positioning, in accordance with some aspects of the present disclosure. In a particular aspect, one or more operations of the method 1000 are performed by the system 100, the device 102, the processor 108, the media selection circuitry 120, the position calculator 121, the classification selector 122, the output selector 124 of FIG. 1, the vehicle 200, the integrated circuit 500, the media selection circuitry 520, the mobile device 600, the vehicle 700, the vehicle 800, the vehicle 900, or a combination thereof.

In some embodiments, the method 1000 includes, at block 1002, performing one or more wireless positioning operations to determine a relative position of a UE of one or more UEs with respect to an interior of a vehicle. The one or more UEs are associated with configurations of a plurality of media services. For example, the position calculator 121 may perform one or more wireless positioning operations with respect to the UEs 150, 152 to generate the first position data 130 and the second position data 132, respectively. In some embodiments, the one or more wireless positioning operations comprise one or more ranging operations according to a UWB protocol, one or more direction operations according to a Bluetooth protocol, one or more channel sounding operations according to the Bluetooth protocol, or a combination thereof.

The method 1000 also includes, at block 1004, identifying a user class associated with the UE based on the relative position of the UE. The user class is associated with permissions for one or more media services of the plurality of media services. For example, the classification selector 122 may identify user classes associated with the UEs 150, 152 based on the first position data 130, the second position data 132, and the vehicle interior data 126 to generate the first class data 134 and the second class data 136. The classes indicated by the first class data 134 and the second class data 136 may be associated with the permissions 111 that indicate respective permissions for the classes that are associated with various services supported by the device 102. In some embodiments, the user class is identified from a group of user classes that comprises operator, non-operator occupant, and child. Additionally, or alternatively, the user class may be identified without profile configuration or instructions from the UE.

The method 1000 also includes, at block 1006, modifying, based on the permissions, a set of configurations that are associated with the one or more media services and the UE. For example, the classification selector 122 or the output selector 124 may modify the media service configurations 110 to modify the configurations of the UEs 150, 152 for one or more of the services indicated by the media service configurations 110. In some embodiments, the plurality of media services includes a hands-free calling service and an audio streaming service.

The method 1000 also includes, at block 1008, selectively enabling playout of audio, via one or more speakers, based on the modified set of configurations. For example, the output selector 124 may generate the output data 138 that corresponds to audio of a selected service and a selected UE based on the first class data 134 and the second class data 136. The output data 138 may be provided to the speakers 117 for playout of audio, to the display device 116 for playout of video or other visual media content, or a combination thereof.

In some embodiments, the method 1000 also includes, based on detection of a trigger condition or according to a preconfigured schedule, performing one or more additional wireless positioning operations to determine an updated relative position of the UE with respect to the interior of the vehicle and determining whether an updated user class that is different from the user class is associated with the UE based on the updated relative position of the UE. In such embodiments, the method 1000 also includes, based on the updated user class being different from the user class, modifying, based on other permissions for the one or more media services that are associated with the updated user class, an additional set of configurations that are associated with the one or more media services and the UE based on other permissions, as well as selectively enabling the playout of the audio, via the one or more speakers, based on the modified additional set of configurations. For example, the vehicle 200 may determine updated user positions and change the media service configurations based on the updated positions, as further described above with reference to FIGS. 3B-3C. In some such embodiments, the trigger condition includes an opening of a door of the vehicle, the vehicle being configured in a stationary mode, a change in a power state of the vehicle, or a combination thereof. Additionally, or alternatively, the trigger condition may be detected during travel by the vehicle.

In some embodiments, the method 1000 includes performing one or more additional wireless positioning operations to determine a relative position of a second UE of the one or more UEs with respect to the interior of the vehicle and identifying a second user class associated with the second UE based on the relative position of the second UE. The second user class is associated with second permissions for the one or more media services of the plurality of media services. For example, the vehicle 200 may determine positions and user classes for the UEs 150, 152, as described above with reference to FIG. 3A. In some such examples, the user class is operator, the second user class is non-operator occupant, and the method 1000 also includes receiving a first request associated with a hands-free calling service from the UE, receiving a second request associated with the hands-free calling service from the second UE, and initiating a hands-free calling session with the UE based on the permissions and the second permissions. In this example, the permissions associated with the hands-free calling service indicate a higher priority than the second permissions associated with the hands-free calling service, and the playout of the audio corresponds to the hands-free calling session. Such an example is further described above with reference to FIG. 3A. Additionally, or alternatively, the method 1000 may also include receiving a first request associated with an audio streaming service from the UE, receiving a second request associated with the audio streaming service from the second UE, and initiating an audio streaming session with the second UE based on the permissions and the second permissions. In this example, the permissions associated with the audio streaming service indicate a lower priority than the second permissions associated with the audio streaming service, and the playout of the audio corresponds to the audio streaming session. Such an example is described above with reference to FIG. 3B.

In some embodiments, the method 1000 includes, to modify the set of configurations based on the permissions: identifying a difference between the permissions and a first configuration of the set of configurations associated with a first media service of the one or more media services and with the UE, and changing the first configuration from a first state to a second state based on the identified difference. For example, the initial configurations 310, 330, or 350 may be modified to generate the modified configurations 314, 334, or 354, as described with reference to FIGS. 3A-3C. In such embodiments, the first state may correspond to enabling access and the second state may correspond to denying access or the first state may correspond to denying access and the second state may correspond to enabling access.

In some embodiments, the one or more media services include a first media service associated with a Bluetooth RFCOMM protocol and a second media service associated with a L2CAP, the permissions permit access to the first media service but not the second media service, and the method 1000 also includes receiving an L2CAP request from the UE and automatically rejecting the L2CAP request based on the second media service being associated with the L2CAP. In such embodiments, the audio that is played out is associated with an RFCOMM request from the UE or an L2CAP request from a second UE. For example, the third request 304 received from the UE 150 may be rejected based on the modified configurations 314, as described above with reference to FIG. 3A.

In some embodiments, the permissions permit access to the first media service but not the second media service, and the method 1000 also includes receiving an ASE enable request from the UE, the ASE enable request including a context field, and automatically rejecting the ASE enable request based on the second media service being indicated by a value of the context field. For example, if the context field of the ASE enable request indicates the second media service (e.g., the media service that the UE is not permitted to access), the device may automatically reject the ASE enable request and not playout audio based on the ASE enable request. In such embodiments, the audio that is played out is associated with the first media service.

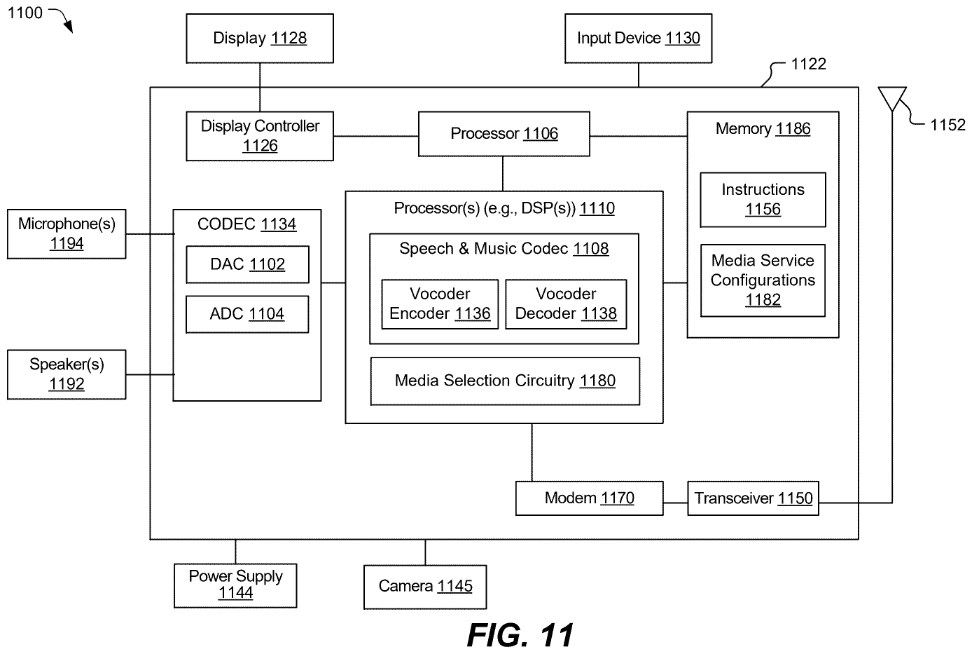

The method 1000 of FIG. 10 may be implemented by a field-programmable gate array (FPGA) device, an application-specific integrated circuit (ASIC), a processing unit such as a central processing unit (CPU), a digital signal processor (DSP), a controller, another hardware device, firmware device, or any combination thereof. As an example, the method 1000 of FIG. 10 may be performed by a processor that executes instructions, such as described with reference to FIG. 11.

It is noted that one or more blocks (or operations) described with reference to FIG. 10 may be combined with one or more blocks (or operations) described with reference to another of the figures. For example, one or more blocks (or operations) of FIG. 10 may be combined with one or more blocks (or operations) associated with FIGS. 1-9. Additionally, or alternatively, one or more operations described above with reference to FIGS. 1-10 may be combined with one or more operations described with reference to FIG. 11.

FIG. 11 is a block diagram of an illustrative example of a device 1100 that is operable to support media configuration and playout based on positioning, in accordance with one or more aspects of the present disclosure. In various implementations, the device 1100 may have more or fewer components than illustrated in FIG. 11. In an illustrative implementation, the device 1100 may correspond to the device 102. In an illustrative implementation, the device 1100 may perform one or more operations described with reference to FIGS. 1-10.

In a particular implementation, the device 1100 includes a processor 1106 (e.g., a central processing unit (CPU)). The device 1100 may include one or more additional processors 1110 (e.g., one or more DSPs). In a particular aspect, the processor 108 of FIG. 1 or the processor 508 of FIG. 5 corresponds to the processor 1106, the processors 1110, or a combination thereof. The processors 1110 may include a speech and music coder-decoder (CODEC) 1108 that includes a voice coder (“vocoder”) encoder 1136, a vocoder decoder 1138, or a combination thereof. Additionally, or alternatively, the processors 1110 may include a media selection circuitry 1180. The media selection circuitry 1180 may include or correspond to the media selection circuitry 120 of FIG. 1 or the media selection circuitry 520 of FIG. 5.

In this context, the term “processor” refers to an integrated circuit consisting of logic cells, interconnects, input/output blocks, clock management components, memory, and optionally other special purpose hardware components, designed to execute instructions and perform various computational tasks. Examples of processors include, without limitation, central processing units (CPUs), digital signal processors (DSPs), neural processing units (NPU), graphics processing units (GPUs), field programmable gate arrays (FPGAs), microcontrollers, quantum processors, coprocessors, vector processors, other similar circuits, and variants and combinations thereof. In some cases, a processor can be integrated with other components, such as communication components, input/output components, etc. to form a system on a chip (SOC) device or a packaged electronic device.

Taking CPUs as a starting point, a CPU typically includes one or more processor cores, each of which includes a complex, interconnected network of transistors and other circuit components defining logic gates, memory elements, etc. A core is responsible for executing instructions to, for example, perform arithmetic and logical operations. Typically, a CPU includes an Arithmetic Logic Unit (ALU) that handles mathematical operations and a Control Unit that generates signals to coordinate the operation of other CPU components, such as to manage operations a fetch-decode-execute cycle.

CPUs and/or individual processor cores generally include local memory circuits, such as registers and cache to temporarily store data during operations. Registers include high-speed, small-sized memory units intimately connected to the logic cells of a CPU. Often registers include transistors arranged as groups of flip-flops, which are configured to store binary data. Caches include fast, on-chip memory circuits used to store frequently accessed data. Caches can be implemented, for example, using Static Random-Access Memory (SRAM) circuits.

Operations of a CPU (e.g., arithmetic operations, logic operations, and flow control operations) are directed by software and firmware. At the lowest level, the CPU includes an instruction set architecture (ISA) that specifies how individual operations are performed using hardware resources (e.g., registers, arithmetic units, etc.). Higher level software and firmware is translated into various combinations of ISA operations to cause the CPU to perform specific higher-level operations. For example, an ISA typically specifies how the hardware components of the CPU move and modify data to perform operations such as addition, multiplication, and subtraction, and high-level software is translated into sets of such operations to accomplish larger tasks, such as adding two columns in a spreadsheet. Generally, a CPU operates on various levels of software, including a kernel, an operating system, applications, and so forth, with each higher level of software generally being more abstracted from the ISA and usually more readily understandable by human users.

GPUs, NPUs, DSPs, microcontrollers, coprocessors, FPGAs, ASICS, and vector processors include components similar to those described above for CPUs. The differences among these various types of processors are generally related to the use of specialized interconnection schemes and ISAs to improve a processor's ability to perform particular types of operations. For example, the logic gates, local memory circuits, and the interconnects therebetween of a GPU are specifically designed to improve parallel processing, sharing of data between processor cores, and vector operations, and the ISA of the GPU may define operations that take advantage of these structures. As another example, ASICs are highly specialized processors that include similar circuitry arranged and interconnected for a particular task, such as encryption or signal processing. As yet another example, FPGAs are programmable devices that include an array of configurable logic blocks (e.g., interconnect sets of transistors and memory elements) that can be configured (often on the fly) to perform customizable logic functions.

The device 1100 may include a memory 1186 and a CODEC 1134. The memory 1186 may include or correspond to the memory 106 of FIG. 1 or the memory 506 of FIG. 5. The memory 1186 may include instructions 1156, that are executable by the one or more additional processors 1110 (or the processor 1106) to implement the functionality described with reference to the media selection circuitry 1180. The instructions 1156 may include or correspond to the instructions 109 of FIG. 1. The memory 1186 also may include media service configurations 1182. The media service configurations 1182 may include or correspond to the media service configurations 110 of FIG. 1 or the media service configurations 532 of FIG. 5. The device 1100 may include a modem 1170 coupled, via a transceiver 1150, to an antenna 1152.

The device 1100 may include a display 1128 coupled to a display controller 1126. One or more speakers 1192, one or more microphone(s) 1194, or both, may be coupled to the CODEC 1134. The microphone(s) 1194 may include or correspond to input device 114 of FIG. 1. The CODEC 1134 may include a digital-to-analog converter (DAC) 1102, an analog-to-digital converter (ADC) 1104, or both. In a particular implementation, the CODEC 1134 may receive analog signals from the microphone(s) 1194, convert the analog signals to digital signals using the analog-to-digital converter 1104, and provide the digital signals to the speech and music codec 1108. The speech and music codec 1108 may process the digital signals. In a particular implementation, the speech and music codec 1108 may provide digital signals to the CODEC 1134. The CODEC 1134 may convert the digital signals to analog signals using the digital-to-analog converter 1102 and may provide the analog signals to the speaker 1192.

In a particular implementation, the device 1100 may be included in a system-in-package or system-on-chip device 1122. In a particular implementation, the memory 1186, the processor 1106, the processors 1110, the display controller 1126, the CODEC 1134, and the modem 1170 are included in the system-in-package or system-on-chip device 1122. In a particular implementation, an input device 1130, a power supply 1144, and a camera 1145 are coupled to the system-in-package or the system-on-chip device 1122. For example, the input device 1130 and the camera 1145 may include or correspond to the input device 114 and the image sensor 112, respectively. In some examples, the input device 1130 may include or be associated with the display device 116 or the display 1128. Moreover, in a particular implementation, as illustrated in FIG. 11, the display 1128, the input device 1130, the speaker(s) 1192, the microphone(s) 1194, the antenna 1152, the power supply 1144, and the camera 1145 are external to the system-in-package or the system-on-chip device 1122. In a particular implementation, each of the display 1128, the input device 1130, the speaker(s) 1192, the microphone(s) 1194, the antenna 1152, the power supply 1144, and the camera 1145 may be coupled to a component of the system-in-package or the system-on-chip device 1122, such as an interface or a controller.

The device 1100 may include a smart speaker, a speaker bar, a mobile communication device, a smart phone, a cellular phone, a laptop computer, a computer, a tablet, a personal digital assistant, a display device, a television, a gaming console, a music player, a radio, a digital video player, a digital video disc (DVD) player, a tuner, a camera, a navigation device, a vehicle, a headset, an augmented reality headset, a mixed reality headset, a virtual reality headset, a home automation system, a voice-activated device, a wireless speaker and voice activated device, a portable electronic device, a vehicle (e.g., a land craft, a water craft, or an aircraft), a computing device, a communication device, an internet-of-things (IoT) device, a virtual reality (VR) device, a base station, a mobile device, or any combination thereof.

In conjunction with the described implementations, an apparatus includes means for means for performing one or more wireless positioning operations to determine a relative position of a UE of one or more UEs with respect to an interior of a vehicle. The one or more UEs are associated with configurations of a plurality of media services. For example, the means for performing can include the wireless interface 104, the media selection circuitry 120, the position calculator 121, the processor 108, the device 102, the system 100, the vehicle 200, the integrated circuit 500, the mobile device 600, the vehicle 700, the vehicle 800, the vehicle 900, the media selection circuitry 1180, the processor 1106, the processor(s) 1110, the system-in-package or the system-on-chip device 1122, the device 1100, other circuitry configured to perform one or more wireless positioning operations to determine a relative position of a UE with respect to an interior of a vehicle, or a combination thereof.

The apparatus also includes means for identifying a user class associated with the UE based on the relative position of the UE. The user class is associated with permissions for one or more media services of the plurality of media services. For example, the means for identifying can include the media selection circuitry 120, the classification selector 122, the processor 108, the device 102, the system 100, the vehicle 200, the integrated circuit 500, the mobile device 600, the vehicle 700, the vehicle 800, the vehicle 900, the media selection circuitry 1180, the processor 1106, the processor(s) 1110, the system-in-package or the system-on-chip device 1122, the device 1100, other circuitry configured to identify a user class associated with the UE based on the relative position of the UE, or a combination thereof.

The apparatus also includes means for modifying, based on the permissions, a set of configurations that are associated with the one or more media services and the UE. For example, the means for modifying can include the media selection circuitry 120, the output selector 124, the processor 108, the device 102, the system 100, the vehicle 200, the integrated circuit 500, the mobile device 600, the vehicle 700, the vehicle 800, the vehicle 900, the media selection circuitry 1180, the processor 1106, the processor(s) 1110, the system-in-package or the system-on-chip device 1122, the device 1100, other circuitry configured to modify, based on the permissions, a set of configurations that are associated with the one or more media services and the UE, or a combination thereof.

The apparatus also includes means for selectively enabling playout of audio, via one or more speakers, based on the modified set of configurations. For example, the means for selectively enabling can include the media selection circuitry 120, the output selector 124, the processor 108, the device 102, the system 100, the vehicle 200, the integrated circuit 500, the mobile device 600, the vehicle 700, the vehicle 800, the vehicle 900, the media selection circuitry 1180, the processor 1106, the processor(s) 1110, the system-in-package or the system-on-chip device 1122, the device 1100, other circuitry configured to selectively enable playout of audio, via one or more speakers, based on the modified set of configurations, or a combination thereof.

In some implementations, a non-transitory computer-readable medium (e.g., a computer-readable storage device, such as the memory 106 or the memory 1186) includes instructions (e.g., the instructions 109 or the instructions 1156) that, when executed by one or more processors (e.g., the processor 108, the one or more processors 1110, or the processor 1106), cause the one or more processors to perform one or more wireless positioning operations to determine a relative position of a UE (e.g., the UE 150 or the UE 152) of one or more UEs with respect to an interior of a vehicle (e.g., the vehicle 200). The one or more UEs are associated with configurations (e.g., the media service configurations 110, the media service configurations 530, or the media service configurations 1182) of a plurality of media services. The instructions also cause the one or more processors to identify a user class associated with the UE based on the relative position of the UE. The user class is associated with permissions for one or more media services of the plurality of media services. The instructions also cause the one or more processors to modify, based on the permissions, a set of configurations (e.g., the media service configurations 110, the media service configurations 530, or the media service configurations 1182) that are associated with the one or more media services and the UE. The instructions also cause the one or more processors to selectively enable playout of audio (e.g., the output data 138 or the output data 572), via one or more speakers (e.g., the speakers 117), based on the modified set of configurations.

Particular aspects of the disclosure are described below in sets of interrelated Examples:
According to Example 1, a device includes: a memory configured to store configurations of a plurality of media services, the configurations associated with one or more user equipments (UEs); and one or more processors, coupled to the memory, where the one or more processors are configured to: perform one or more wireless positioning operations to determine a relative position of a UE of the one or more UEs with respect to an interior of a vehicle; identify a user class associated with the UE based on the relative position of the UE, the user class associated with permissions for one or more media services of the plurality of media services; modify, based on the permissions, a set of configurations that are associated with the one or more media services and the UE; and selectively enable playout of audio, via one or more speakers, based on the modified set of configurations.

Example 2 includes the device of Example 1, where the one or more wireless positioning operations include one or more ranging operations according to an ultra-wideband (UWB) protocol, one or more direction operations according to a Bluetooth protocol, one or more channel sounding operations according to the Bluetooth protocol, or a combination thereof.

Example 3 includes the device of Example 1 or Example 2, where the user class is identified from a group of user classes that includes operator, non-operator occupant, and child.

Example 4 includes the device of any of Examples 1 to 3, where the plurality of media services includes a hands-free calling service and an audio streaming service.

Example 5 includes the device of any of Examples 1 to 4, where the user class is identified without profile configuration or instructions from the UE.

Example 6 includes the device of any of Examples 1 to 5, where the one or more processors are configured to: based on detection of a trigger condition or according to a preconfigured schedule, perform one or more additional wireless positioning operations to determine an updated relative position of the UE with respect to the interior of the vehicle; determine whether an updated user class that is different from the user class is associated with the UE based on the updated relative position of the UE; based on the updated user class being different from the user class, modify, based on other permissions for the one or more media services that are associated with the updated user class, an additional set of configurations that are associated with the one or more media services and the UE based on other permissions; and selectively enable the playout of the audio, via the one or more speakers, based on the modified additional set of configurations.

Example 7 includes the device of Example 6, where the trigger condition includes an opening of a door of the vehicle, the vehicle being configured in a stationary mode, a change in a power state of the vehicle, or a combination thereof.

Example 8 includes the device of Example 6 or Example 7, where the trigger condition is detected during travel by the vehicle.

Example 9 includes the device of any of Examples 1 to 8, where the one or more processors are configured to: perform one or more additional wireless positioning operations to determine a relative position of a second UE of the one or more UEs with respect to the interior of the vehicle; and identify a second user class associated with the second UE based on the relative position of the second UE, the second user class associated with second permissions for the one or more media services of the plurality of media services.

Example 10 includes the device of Example 9, where the user class is operator, where the second user class is non-operator occupant, and where the one or more processors are configured to: receive a first request associated with a hands-free calling service from the UE; receive a second request associated with the hands-free calling service from the second UE, where the permissions associated with the hands-free calling service indicate a higher priority than the second permissions associated with the hands-free calling service; and initiate a hands-free calling session with the UE based on the permissions and the second permissions, where the playout of the audio corresponds to the hands-free calling session.

Example 11 includes the device of Example 9 or Example 10, where the user class is operator, where the second user class is non-operator occupant, and where the one or more processors are configured to: receive a first request associated with an audio streaming service from the UE; receive a second request associated with the audio streaming service from the second UE, where the permissions associated with the audio streaming service indicate a lower priority than the second permissions associated with the audio streaming service; and initiate an audio streaming session with the second UE based on the permissions and the second permissions, where the playout of the audio corresponds to the audio streaming session.

Example 12 includes the device of any of Examples 1 to 11, where, to modify the set of configurations based on the permissions, the one or more processors are configured to: identify a difference between the permissions and a first configuration of the set of configurations associated with a first media service of the one or more media services and with the UE; and change the first configuration from a first state to a second state based on the identified difference, where: the first state corresponds to enabling access and the second state corresponds to denying access, or the first state corresponds to denying access and the second state corresponds to enabling access.

Example 13 includes the device of any of Examples 1 to 12, where the one or more media services include a first media service associated with a Bluetooth radio frequency communication (RFCOMM) protocol and a second media service associated with a logical link control and adaptation protocol (L2CAP), where the permissions permit access to the first media service but not the second media service, and where the one or more processors are configured to: receive an L2CAP request from the UE; and automatically reject the L2CAP request based on the second media service being associated with the L2CAP, where the audio that is played out is associated with an RFCOMM request from the UE or an L2CAP request from a second UE.

Example 14 includes the device of any of Examples 1 to 13 where the permissions permit access to a first media service of the one or more media services but not a second media service of the one or more media services; and where the one or more processors are configured to: receive an ASE enable request from the UE, the ASE enable request including a context field; and automatically reject the ASE enable request based on the second media service being indicated by a value of the context field, wherein the audio that is played out is associated with the first media service.

Example 15 includes the device of any of Examples 1 to 14 and also includes one or more wireless interfaces configured to transmit, receive, or both, one or more signals associated with the one or more wireless positioning operations.

Example 16 includes the device of any of Examples 1 to 15, where the one or more processors are included in an integrated circuit.

Example 17 includes the device of any of Examples 1 to 16, where the UE includes a mobile phone, a tablet computer device, or a wearable electronic device within the interior of the vehicle.

Example 18 includes the device of any of Examples 1 to 17, further comprising a modem configured to receive a connection request that complies with a logical link control and adaption protocol (L2CAP) and associated with a media service of the one or more media services.

According to Example 19, a method includes: performing, by one or more processors, one or more wireless positioning operations to determine a relative position of a user equipment (UE) of one or more UEs with respect to an interior of a vehicle, the one or more UEs associated with configurations of a plurality of media services; identifying, by the one or more processors, a user class associated with the UE based on the relative position of the UE, the user class associated with permissions for one or more media services of the plurality of media services; modifying, by the one or more processors and based on the permissions, a set of configurations that are associated with the one or more media services and the UE; and selectively enabling playout of audio, by the one or more processors and via one or more speakers, based on the modified set of configurations.

Example 20 includes the method of Example 19, where the one or more wireless positioning operations include one or more ranging operations according to an ultra-wideband (UWB) protocol, one or more direction operations according to a Bluetooth protocol, one or more channel sounding operations according to the Bluetooth protocol, or a combination thereof.

Example 21 includes the method of Example 19 or Example 20, where the user class is identified from a group of user classes that includes operator, non-operator occupant, and child.

Example 22 includes the method of any of Examples 19 to 21, where the plurality of media services includes a hands-free calling service and an audio streaming service.

Example 23 includes the method of any of Examples 19 to 22, where the user class is identified without profile configuration or instructions from the UE.

Example 24 includes the method of any of Examples 19 to 23 and also includes: based on detection of a trigger condition or according to a preconfigured schedule, performing one or more additional wireless positioning operations to determine an updated relative position of the UE with respect to the interior of the vehicle; determining whether an updated user class that is different from the user class is associated with the UE based on the updated relative position of the UE; based on the updated user class being different from the user class, modifying, based on other permissions for the one or more media services that are associated with the updated user class, an additional set of configurations that are associated with the one or more media services and the UE based on other permissions; and selectively enabling the playout of the audio, via the one or more speakers, based on the modified additional set of configurations.

Example 25 includes the method of Example 24, where the trigger condition includes an opening of a door of the vehicle, the vehicle being configured in a stationary mode, a change in a power state of the vehicle, or a combination thereof.
Example 26 includes the method of Example 24 or Example 25, where the trigger condition is detected during travel by the vehicle.

Example 27 includes the method of any of Examples 19 to 26 and also includes: performing one or more additional wireless positioning operations to determine a relative position of a second UE of the one or more UEs with respect to the interior of the vehicle; and identifying a second user class associated with the second UE based on the relative position of the second UE, the second user class associated with second permissions for the one or more media services of the plurality of media services.

Example 28 includes the method of Example 27, where the user class is operator, where the second user class is non-operator occupant, and where the method also includes: receiving a first request associated with a hands-free calling service from the UE; receiving a second request associated with the hands-free calling service from the second UE, where the permissions associated with the hands-free calling service indicate a higher priority than the second permissions associated with the hands-free calling service; and initiating a hands-free calling session with the UE based on the permissions and the second permissions, where the playout of the audio corresponds to the hands-free calling session.

Example 29 includes the method of Example 27 or Example 28, where the user class is operator, where the second user class is non-operator occupant, and where the method also includes: receiving a first request associated with an audio streaming service from the UE; receiving a second request associated with the audio streaming service from the second UE, where the permissions associated with the audio streaming service indicate a lower priority than the second permissions associated with the audio streaming service; and initiating an audio streaming session with the second UE based on the permissions and the second permissions, where the playout of the audio corresponds to the audio streaming session.

Example 30 includes the method of any of Examples 19 to 29, and further includes, to modify the set of configurations based on the permissions: identifying a difference between the permissions and a first configuration of the set of configurations associated with a first media service of the one or more media services and with the UE; and changing the first configuration from a first state to a second state based on the identified difference, where: the first state corresponds to enabling access and the second state corresponds to denying access, or the first state corresponds to denying access and the second state corresponds to enabling access.

Example 31 includes the method of any of Examples 19 to 30, where the one or more media services include a first media service associated with a Bluetooth radio frequency communication (RFCOMM) protocol and a second media service associated with a logical link control and adaptation protocol (L2CAP), where the permissions permit access to the first media service but not the second media service, and where method also includes: receiving an L2CAP request from the UE; and automatically rejecting the L2CAP request based on the second media service being associated with the L2CAP, where the audio that is played out is associated with an RFCOMM request from the UE or an L2CAP request from a second UE.

According to Example 32, a non-transitory computer readable storage medium that stores instructions that, when executed by one or more processors, cause the one or more processors to: perform one or more wireless positioning operations to determine a relative position of a user equipment (UE) of one or more UEs with respect to an interior of a vehicle, the one or more UEs associated with configurations of a plurality of media services; identify a user class associated with the UE based on the relative position of the UE, the user class associated with permissions for one or more media services of the plurality of media services; modify, based on the permissions, a set of configurations that are associated with the one or more media services and the UE; and selectively enable playout of audio, via one or more speakers, based on the modified set of configurations.

Example 33 includes the non-transitory computer readable storage medium of Example 32, where the one or more wireless positioning operations include one or more ranging operations according to an ultra-wideband (UWB) protocol, one or more direction operations according to a Bluetooth protocol, one or more channel sounding operations according to the Bluetooth protocol, or a combination thereof.

Example 34 includes the non-transitory computer readable storage medium of Example 32 or Example 33, where the user class is identified from a group of user classes that includes operator, non-operator occupant, and child.

Example 35 includes the non-transitory computer readable storage medium of any of Examples 32 to 34, where the plurality of media services includes a hands-free calling service and an audio streaming service.

Example 36 includes the non-transitory computer readable storage medium of any of Examples 32 to 35, where the user class is identified without profile configuration or instructions from the UE.

Example 37 includes the non-transitory computer readable storage medium of any of Examples 32 to 36, where the instructions, when executed by the one or more processors, cause the one or more processors to: based on detection of a trigger condition or according to a preconfigured schedule, perform one or more additional wireless positioning operations to determine an updated relative position of the UE with respect to the interior of the vehicle; determine whether an updated user class that is different from the user class is associated with the UE based on the updated relative position of the UE; based on the updated user class being different from the user class, modify, based on other permissions for the one or more media services that are associated with the updated user class, an additional set of configurations that are associated with the one or more media services and the UE based on other permissions; and selectively enable the playout of the audio, via the one or more speakers, based on the modified additional set of configurations.

Example 38 includes the non-transitory computer readable storage medium of Example 37, where the trigger condition includes an opening of a door of the vehicle, the vehicle being configured in a stationary mode, a change in a power state of the vehicle, or a combination thereof.

Example 39 includes the non-transitory computer readable storage medium of Example 37 or Example 38, where the trigger condition is detected during travel by the vehicle.

Example 40 includes the non-transitory computer readable storage medium of any of Examples 32 to 39, where the instructions, when executed by the one or more processors, cause the one or more processors to: perform one or more additional wireless positioning operations to determine a relative position of a second UE of the one or more UEs with respect to the interior of the vehicle; and identify a second user class associated with the second UE based on the relative position of the second UE, the second user class associated with second permissions for the one or more media services of the plurality of media services.

Example 41 includes the non-transitory computer readable storage medium of Example 40, where the user class is operator, where the second user class is non-operator occupant, and where the instructions, when executed by the one or more processors, cause the one or more processors to: receive a first request associated with a hands-free calling service from the UE; receive a second request associated with the hands-free calling service from the second UE, where the permissions associated with the hands-free calling service indicate a higher priority than the second permissions associated with the hands-free calling service; and initiate a hands-free calling session with the UE based on the permissions and the second permissions, where the playout of the audio corresponds to the hands-free calling session.

Example 42 includes the non-transitory computer readable storage medium of Example 40 or Example 41, where the user class is operator, where the second user class is non-operator occupant, and where the instructions, when executed by the one or more processors, cause the one or more processors to: receive a first request associated with an audio streaming service from the UE; receive a second request associated with the audio streaming service from the second UE, where the permissions associated with the audio streaming service indicate a lower priority than the second permissions associated with the audio streaming service; and initiate an audio streaming session with the second UE based on the permissions and the second permissions, where the playout of the audio corresponds to the audio streaming session.

Example 43 includes the non-transitory computer readable storage medium of any of Examples 32 to 42, where, to modify the set of configurations based on the permissions, the instructions, when executed by the one or more processors, cause the one or more processors to: identify a difference between the permissions and a first configuration of the set of configurations associated with a first media service of the one or more media services and with the UE; and change the first configuration from a first state to a second state based on the identified difference, where: the first state corresponds to enabling access and the second state corresponds to denying access, or the first state corresponds to denying access and the second state corresponds to enabling access.

Example 44 includes the non-transitory computer readable storage medium of any of Examples 32 to 43, where the one or more media services include a first media service associated with a Bluetooth radio frequency communication (RFCOMM) protocol and a second media service associated with a logical link control and adaptation protocol (L2CAP), where the permissions permit access to the first media service but not the second media service, and where the instructions, when executed by the one or more processors, cause the one or more processors to: receive an L2CAP request from the UE; and automatically reject the L2CAP request based on the second media service being associated with the L2CAP, where the audio that is played out is associated with an RFCOMM request from the UE or an L2CAP request from a second UE.

According to Example 45, an apparatus includes: means for performing one or more wireless positioning operations to determine a relative position of a user equipment (UE) of one or more UEs with respect to an interior of a vehicle, the one or more UEs associated with configurations of a plurality of media services; means for identifying a user class associated with the UE based on the relative position of the UE, the user class associated with permissions for one or more media services of the plurality of media services; means for modifying, based on the permissions, a set of configurations that are associated with the one or more media services and the UE; and means for selectively enabling playout of audio, via one or more speakers, based on the modified set of configurations.

Example 46 includes the apparatus of Example 45, where the one or more wireless positioning operations include one or more ranging operations according to an ultra-wideband (UWB) protocol, one or more direction operations according to a Bluetooth protocol, one or more channel sounding operations according to the Bluetooth protocol, or a combination thereof.

Example 47 includes the apparatus of Example 45 or Example 46, where the user class is identified from a group of user classes that includes operator, non-operator occupant, and child.

Example 48 includes the apparatus of any of Examples 45 to 47, where the plurality of media services includes a hands-free calling service and an audio streaming service.

Example 49 includes the apparatus of any of Examples 45 to 48, where the user class is identified without profile configuration or instructions from the UE.

Example 50 includes the apparatus of any of Examples 45 to 49 and also includes: means for performing, based on detection of a trigger condition or according to a preconfigured schedule, one or more additional wireless positioning operations to determine an updated relative position of the UE with respect to the interior of the vehicle; means for determining whether an updated user class that is different from the user class is associated with the UE based on the updated relative position of the UE; means for modifying, responsive to the updated user class being different from the user class and based on other permissions for the one or more media services that are associated with the updated user class, an additional set of configurations that are associated with the one or more media services and the UE based on other permissions; and means for selectively enabling the playout of the audio, via the one or more speakers, based on the modified additional set of configurations.

Example 51 includes the apparatus of Example 50, where the trigger condition includes an opening of a door of the vehicle, the vehicle being configured in a stationary mode, a change in a power state of the vehicle, or a combination thereof.

Example 52 includes the apparatus of Example 50 or Example 51, where the trigger condition is detected during travel by the vehicle.

Example 53 includes the apparatus of any of Examples 45 to 52 and also includes: means for performing one or more additional wireless positioning operations to determine a relative position of a second UE of the one or more UEs with respect to the interior of the vehicle; and means for identifying a second user class associated with the second UE based on the relative position of the second UE, the second user class associated with second permissions for the one or more media services of the plurality of media services.

Example 54 includes the apparatus of Example 53, where the user class is operator, where the second user class is non-operator occupant, and where the apparatus also includes: means for receiving a first request associated with a hands-free calling service from the UE; means for receiving a second request associated with the hands-free calling service from the second UE, where the permissions associated with the hands-free calling service indicate a higher priority than the second permissions associated with the hands-free calling service; and means for initiating a hands-free calling session with the UE based on the permissions and the second permissions, where the playout of the audio corresponds to the hands-free calling session.

Example 55 includes the apparatus of Example 53 or Example 54, where the user class is operator, where the second user class is non-operator occupant, and where the apparatus also includes: means for receiving a first request associated with an audio streaming service from the UE; means for receiving a second request associated with the audio streaming service from the second UE, where the permissions associated with the audio streaming service indicate a lower priority than the second permissions associated with the audio streaming service; and means for initiating an audio streaming session with the second UE based on the permissions and the second permissions, where the playout of the audio corresponds to the audio streaming session.

Example 56 includes the apparatus of any of Examples 45 to 55, and further includes, to modify the set of configurations based on the permissions: means for identifying a difference between the permissions and a first configuration of the set of configurations associated with a first media service of the one or more media services and with the UE; and means for changing the first configuration from a first state to a second state based on the identified difference, where: the first state corresponds to enabling access and the second state corresponds to denying access, or the first state corresponds to denying access and the second state corresponds to enabling access.

Example 57 includes the apparatus of any of Examples 45 to 56, where the one or more media services include a first media service associated with a Bluetooth radio frequency communication (RFCOMM) protocol and a second media service associated with a logical link control and adaptation protocol (L2CAP), where the permissions permit access to the first media service but not the second media service, and where apparatus also includes: means for receiving an L2CAP request from the UE; and means for automatically rejecting the L2CAP request based on the second media service being associated with the L2CAP, where the audio that is played out is associated with an RFCOMM request from the UE or an L2CAP request from a second UE.

Those of skill would further appreciate that the various illustrative logical blocks, configurations, modules, circuits, and algorithm steps described in connection with the implementations disclosed herein may be implemented as electronic hardware, computer software executed by a processor, or combinations of both. Various illustrative components, blocks, configurations, modules, circuits, and steps have been described above generally in terms of their functionality. Whether such functionality is implemented as hardware or processor executable instructions depends upon the particular application and design constraints imposed on the overall system. Skilled artisans may implement the described functionality in varying ways for each particular application, such implementation decisions are not to be interpreted as causing a departure from the scope of the present disclosure.

The steps of a method or algorithm described in connection with the implementations disclosed herein may be embodied directly in hardware, in a software module executed by a processor, or in a combination of the two. A software module may reside in random access memory (RAM), flash memory, read-only memory (ROM), programmable read-only memory (PROM), erasable programmable read-only memory (EPROM), electrically erasable programmable read-only memory (EEPROM), registers, hard disk, a removable disk, a compact disc read-only memory (CD-ROM), or any other form of non-transient storage medium known in the art. An exemplary storage medium is coupled to the processor such that the processor may read information from, and write information to, the storage medium. In the alternative, the storage medium may be integral to the processor. The processor and the storage medium may reside in an application-specific integrated circuit (ASIC). The ASIC may reside in a computing device or a user terminal. In the alternative, the processor and the storage medium may reside as discrete components in a computing device or user terminal.

The previous description of the disclosed aspects is provided to enable a person skilled in the art to make or use the disclosed aspects. Various modifications to these aspects will be readily apparent to those skilled in the art, and the principles defined herein may be applied to other aspects without departing from the scope of the disclosure. Thus, the present disclosure is not intended to be limited to the aspects shown herein but is to be accorded the widest scope possible consistent with the principles and novel features as defined by the following claims.

What is claimed is:

1. A device comprising:
a memory configured to store configurations of a plurality of media services, the configurations associated with one or more user equipments (UEs); and
one or more processors, coupled to the memory, wherein the one or more processors are configured to:
perform one or more wireless positioning operations to determine a relative position of a UE of the one or more UEs with respect to an interior of a vehicle;
identify a user class associated with the UE based on the relative position of the UE, the user class associated with permissions for one or more media services of the plurality of media services;
modify, based on the permissions, a set of configurations that are associated with the one or more media services and the UE; and
selectively enable playout of audio, via one or more speakers, based on the modified set of configurations.

2. The device of claim 1, wherein the one or more wireless positioning operations comprise one or more ranging operations according to an ultra-wideband (UWB) protocol, one or more direction operations according to a Bluetooth protocol, one or more channel sounding operations according to the Bluetooth protocol, or a combination thereof.

3. The device of claim 1, wherein the user class is identified from a group of user classes that comprises operator, non-operator occupant, and child.

4. The device of claim 1, wherein the plurality of media services includes a hands-free calling service and an audio streaming service.

5. The device of claim 1, wherein the user class is identified without profile configuration or instructions from the UE.

6. The device of claim 1, wherein the one or more processors are configured to:
based on detection of a trigger condition or according to a preconfigured schedule, perform one or more additional wireless positioning operations to determine an updated relative position of the UE with respect to the interior of the vehicle;
determine whether an updated user class that is different from the user class is associated with the UE based on the updated relative position of the UE;
based on the updated user class being different from the user class, modify, based on other permissions for the one or more media services that are associated with the updated user class, an additional set of configurations that are associated with the one or more media services and the UE based on other permissions; and
selectively enable the playout of the audio, via the one or more speakers, based on the modified additional set of configurations.

7. The device of claim 6, wherein the trigger condition includes an opening of a door of the vehicle, the vehicle being configured in a stationary mode, a change in a power state of the vehicle, or a combination thereof.

8. The device of claim 6, wherein the trigger condition is detected during travel by the vehicle.

9. The device of claim 1, wherein the one or more processors are configured to:
perform one or more additional wireless positioning operations to determine a relative position of a second UE of the one or more UEs with respect to the interior of the vehicle; and
identify a second user class associated with the second UE based on the relative position of the second UE, the second user class associated with second permissions for the one or more media services of the plurality of media services.

10. The device of claim 9, wherein the user class is operator, wherein the second user class is non-operator occupant, and wherein the one or more processors are configured to:
receive a first request associated with a hands-free calling service from the UE;
receive a second request associated with the hands-free calling service from the second UE, wherein the permissions associated with the hands-free calling service indicate a higher priority than the second permissions associated with the hands-free calling service; and
initiate a hands-free calling session with the UE based on the permissions and the second permissions, wherein the playout of the audio corresponds to the hands-free calling session.

11. The device of claim 9, wherein the user class is operator, wherein the second user class is non-operator occupant, and wherein the one or more processors are configured to:
receive a first request associated with an audio streaming service from the UE;
receive a second request associated with the audio streaming service from the second UE, wherein the permissions associated with the audio streaming service indicate a lower priority than the second permissions associated with the audio streaming service; and
initiate an audio streaming session with the second UE based on the permissions and the second permissions, wherein the playout of the audio corresponds to the audio streaming session.

12. The device of claim 1, wherein, to modify the set of configurations based on the permissions, the one or more processors are configured to:
identify a difference between the permissions and a first configuration of the set of configurations associated with a first media service of the one or more media services and with the UE; and
change the first configuration from a first state to a second state based on the identified difference, wherein:
the first state corresponds to enabling access and the second state corresponds to denying access, or
the first state corresponds to denying access and the second state corresponds to enabling access.

13. The device of claim 1, wherein the one or more media services include a first media service associated with a Bluetooth radio frequency communication (RFCOMM) protocol and a second media service associated with a logical link control and adaptation protocol (L2CAP), wherein the permissions permit access to the first media service but not the second media service, and wherein the one or more processors are configured to:
receive an L2CAP request from the UE; and
automatically reject the L2CAP request based on the second media service being associated with the L2CAP, wherein the audio that is played out is associated with an RFCOMM request from the UE or an L2CAP request from a second UE.

14. The device of claim 1, wherein the permissions permit access to a first media service of the one or more media services but not a second media service of the one or more media services, and wherein the one or more processors are configured to:
receive an audio stream endpoint (ASE) enable request from the UE, the ASE enable request including a context field; and
automatically reject the ASE enable request based on the second media service being indicated by a value of the context field, wherein the audio that is played out is associated with the first media service.

15. The device of claim 1, further comprising one or more wireless interfaces configured to transmit, receive, or both, one or more signals associated with the one or more wireless positioning operations.

16. The device of claim 1, wherein the one or more processors are included in an integrated circuit.

17. The device of claim 1, wherein the UE comprises a mobile phone, a tablet computer device, or a wearable electronic device within the interior of the vehicle.

18. The device of claim 1, further comprising a modem configured to receive a connection request that complies with a logical link control and adaption protocol (L2CAP) and associated with a media service of the one or more media services.

19. A method comprising:
performing, by one or more processors, one or more wireless positioning operations to determine a relative position of a user equipment (UE) of one or more UEs with respect to an interior of a vehicle, the one or more UEs associated with configurations of a plurality of media services;
identifying, by the one or more processors, a user class associated with the UE based on the relative position of the UE, the user class associated with permissions for one or more media services of the plurality of media services;
modifying, by the one or more processors and based on the permissions, a set of configurations that are associated with the one or more media services and the UE; and
selectively enabling playout of audio, by the one or more processors and via one or more speakers, based on the modified set of configurations.

20. A non-transitory computer readable storage medium that stores instructions that, when executed by one or more processors, cause the one or more processors to:
performing one or more wireless positioning operations to determine a relative position of a user equipment (UE) of one or more UEs with respect to an interior of a vehicle, the one or more UEs associated with configurations of a plurality of media services;
identifying a user class associated with the UE based on the relative position of the UE, the user class associated with permissions for one or more media services of the plurality of media services;
modifying, based on the permissions, a set of configurations that are associated with the one or more media services and the UE; and
selectively enabling playout of audio, via one or more speakers, based on the modified set of configurations.
